(19) United States
(12) Patent Application Publication
(10) Pub. No.: US 2026/0116411 A1
(43) Pub. Date: Apr. 30, 2026

(54) DETERMINATION OF DEVIATION IN VEHICLE DRIVING BEHAVIOR AND GENERATING RECOMMENDATIONS THEREOF

(71) Applicant: HERE GLOBAL B.V., EINDHOVEN (NL)

(72) Inventors: JEROME BEAUREPAIRE, NANTES (FR); JEREMY MICHAEL YOUNG, BEVERLY HILLS, MI (US)

(73) Assignee: HERE GLOBAL B.V., EINDHOVEN (NL)

(21) Appl. No.: 18/929,639

(22) Filed: Oct. 29, 2024

(51) Int. Cl. B60W 50/14; B60H 1/00; G07C 5/00; G07C 5/04

(52) U.S. Cl. CPC B60W 50/14; B60H 1/0065; G07C 5/004; G07C 5/04; B60W 2050/146; B60W 2540/215

(57) ABSTRACT

An apparatus for dynamic determination of deviation in vehicle driving behavior and generating recommendations thereof is disclosed. The apparatus retrieves user profile data associated with a user of a vehicle. The user profile data includes historical usage information of the vehicle during one or more historical driving sessions by the user. The apparatus further obtains first contextual information associated with a first driving session by the user. The apparatus further determines a deviation associated with a usage of the vehicle based on the retrieved user profile data and the obtained first contextual information. The apparatus further generates a recommendation associated with a modification in a driving range of the vehicle based on the determined deviation and provides, via a user interface, the generated recommendation.

### TECHNOLOGICAL FIELD

The present disclosure generally relates to generating recommendations for vehicles, and more particularly relates to an apparatus for determining deviations in vehicle driving behavior and generating recommendations thereof.

### BACKGROUND

With advancements in the field of automotive engineering, electric vehicles offer a promising solution to reduce carbon emissions and mitigate climate change. However, one of the challenges hindering the adoption of electric vehicles is the uncertainty surrounding a driving range of electric vehicles. The driving range of the electric vehicle refers to the distance that the electric vehicle can travel on a single battery charge. Typically, various factors influence the driving range of electric vehicles. One crucial factor affecting the driving range of electric vehicles is weather conditions around the electric vehicle. For example, extreme temperatures, whether hot or cold, significantly impact battery performance and efficiency. In cold weather, batteries experience decreased efficiency and capacity, leading to reduced range, while in hot weather, excessive heat may accelerate battery degradation. Additionally, precipitation such as rain or snow may affect driving conditions and increase energy consumption, further reducing the driving range.

Another factor influencing the driving range is the usage of climate control systems in vehicles. Heating and cooling systems in electric vehicles consume energy from the battery, thereby reducing the available driving range, especially in extreme weather conditions. Moreover, driving behavior and acceleration patterns play a crucial role in determining the driving range. For example, aggressive driving, frequent acceleration, braking, and high-speed driving may significantly reduce efficiency and shorten the driving range. Conversely, adopting smoother driving habits and optimizing acceleration and braking can help maximize the driving range. Another factor responsible for determining the driving range of the electric vehicle is the terrain. For example, driving uphill consumes more energy than driving on a flat terrain. While existing technology can predict range based on driving patterns, traffic patterns, and weather conditions, there are certain limitations associated in addition to that.

Therefore, there is a need to provide accurate range prediction, thereby helping electric vehicle drivers mitigate driving range anxiety and providing effective recommendations to make their commute within the available charge.

### BRIEF SUMMARY OF SOME EXAMPLE EMBODIMENTS

An apparatus, a method, and a computer programmable product are provided for determining a deviation in vehicle driving behavior and generating recommendations thereof.

In one embodiment, an apparatus for dynamic determination of deviation in vehicle driving behavior and generating recommendation thereof is disclosed. The apparatus includes at least one processor and at least one non-transitory memory including computer program code instructions, the computer program code instructions configured to, when executed, cause the apparatus to retrieve user profile data associated with a user of a vehicle. The user profile data may include historical usage information of the vehicle during one or more historical driving sessions by the user. The computer program code instructions are configured to when executed, cause the apparatus to obtain first contextual information associated with a first driving session by the user. The computer program code instructions are also configured to, when executed, cause the apparatus to determine a deviation associated with a usage of the vehicle based on the retrieved user profile data and the obtained first contextual information. The computer program code instructions are also configured to, when executed, cause the apparatus to generate a recommendation associated with a modification in a driving range of the vehicle based on the determined deviation. The computer program code instructions are also configured to, when executed, cause the apparatus to provide, via a user interface, the generated recommendation as an option for selection by the user.

In another embodiment, the vehicle is an electric vehicle. The user profile data may further include charging information associated with one or more historical charging sessions of the electric vehicle.

In another embodiment, the charging information associated with the one or more historical charging sessions of the electric vehicle may include timestamp information associated with each charging session of the one or more historical charging sessions, location information associated with each charging session of the one or more historical charging sessions, cost information associated with each charging session of the one or more historical charging sessions or a combination thereof.

In another embodiment, the historical usage information of the vehicle may include timestamp information associated with each driving session of the one or more historical driving sessions, route information associated with each driving session of the one or more historical driving sessions, weather information associated with a location of the vehicle or a route be traversed by the vehicle during each driving session of the one or more historical driving sessions, occupancy information associated with the vehicle during each driving session of the one or more historical driving sessions, speed information associated with the vehicle during each driving session of the one or more historical driving sessions, vehicle information associated with the vehicle, or a combination thereof.

In another embodiment, the first contextual information associated with the vehicle may include vehicle information associated with the vehicle during the first driving session, charging information associated with the vehicle during the first driving session, route information associated with the first driving session, traffic information associated with a route to be traversed by the vehicle during the first driving session, weather information associated with a location of the vehicle or the route to be traversed by the vehicle during the first driving session, or a combination thereof.

In another embodiment, the deviation in the usage of the vehicle during the first driving session is determined based on one of a modification in vehicle health information associated with the vehicle, a modification in charge information associated with the vehicle, a modification in speed information associated with the vehicle, a modification in route information associated with the first driving session, a modification in traffic information associated with a route to be traversed by the vehicle, a modification in occupancy information associated with the vehicle during the first driving session, environment information during the first driving session, or a combination thereof.

In another embodiment, the generated recommendation associated with the modification in the driving range of the vehicle may correspond to a modification in a speed associated with the vehicle, a modification in charge information associated with the vehicle, a modification in vehicle health information associated with the vehicle, a modification in a route to be traversed by the vehicle, a modification in one or more parameters of one or more electronic devices associated with the vehicle, a modification in a start time associated with the first driving session, or a combination thereof.

In another embodiment, the one or more electronic devices associated with the vehicle may include at least one of a Heating, Ventilation, and Air Conditioning system, an infotainment system, an on-board diagnostics system, a Tire Pressure Monitoring System, a Battery Management System, a vehicle control unit, a navigation system, and an Advanced Driver Assistance System.

In another embodiment, the computer program code instructions are configured to, when executed, cause the apparatus to control one or more parameters of one or more electronic devices associated with the vehicle based on a selection of the generated recommendation.

In another embodiment, the computer program code instructions are configured to, when executed, cause the apparatus to receive a user input associated with the modification in the driving range of the vehicle. The computer program code instructions are configured to, when executed, cause the apparatus to generate the recommendation associated with the modification in the driving range of the vehicle based on the received user input.

In another embodiment, the computer program code instructions are configured to, when executed, cause the apparatus to receive a user input associated with a modification in one or more parameters of one or more electronic devices associated with the vehicle based on the generated recommendation. The computer program code instructions are configured to, when executed, cause the apparatus to control the one or more parameters of the one or more electronic devices associated with the vehicle based on the received user input.

In another embodiment, the computer program code instructions are configured to, when executed, cause the apparatus to apply a machine learning model on the retrieved user profile data and the obtained first contextual information. The computer program code instructions are configured to, when executed, cause the apparatus to generate the recommendation associated with the modification in the driving range of the vehicle based on an output of the machine learning model.

In one embodiment, a method for providing a user with a recommendation associated with a modification in a driving range of a vehicle is disclosed. The method includes steps of retrieving user profile data associated with the user of the vehicle. The user profile data includes historical usage information of the vehicle during one or more historical driving sessions by the user. The method further includes steps of obtaining contextual information associated with a first driving session by the user. The method further includes steps of determining a deviation associated with a usage of the vehicle based on the retrieved user profile data and the obtained first contextual information. The method further includes steps of generating the recommendation associated with the modification in the driving range of the vehicle based on the determined deviation. The method further includes steps of rendering the generated recommendation on a user interface as an option for selection by the user.

In another embodiment, the vehicle is an electric vehicle. The user profile data further includes charging information associated with one or more historical charging sessions of the electric vehicle.

In another embodiment, the method includes steps of receiving a user input associated with the modification in the driving range of the vehicle. The method further includes steps of generating the recommendation associated with the modification in the driving range of the vehicle based on the received user input.

In another embodiment, the method includes receiving a user input associated with a modification in one or more parameters of one or more electronic devices associated with the vehicle based on the generated recommendation. The method further includes controlling the one or more parameters of the one or more electronic devices associated with the vehicle based on the received user input.

In another embodiment, a user interface is displayed on at least one of an infotainment unit associated with the vehicle, or a user device associated with the user of the vehicle.

In one embodiment, a computer program product including a non-transitory computer readable medium having stored thereon computer executable instructions which when executed by at least one processor, cause the processor to carry out dynamic determination of deviation in vehicle driving behavior and generating recommendation thereof. The operations include retrieving user profile data associated with a user of a vehicle. The user profile data may include historical usage information of the vehicle during one or more historical driving sessions by the user. The operations further include obtaining first contextual information associated with a first driving session by the user. The operations further include determining a deviation associated with a usage of the vehicle based on the retrieved user profile data and the obtained first contextual information. The operations further include generating a recommendation associated with a modification in a driving range of the vehicle based on the determined deviation. The operations further include providing, via a user interface, the generated recommendations as an option for selection by the user.

In another embodiment, the operations further include receiving a user input associated with the modification in the driving range of the vehicle. The operations further include generating the recommendation associated with the modification in the driving range of the vehicle based on the received user input.

In another embodiment, the operations further include receiving a user input associated with a modification in one or more parameters of one or more electronic devices associated with the vehicle based on the generated recommendation. The operations further include controlling the one or more parameters of the one or more electronic devices associated with the vehicle based on the received user input.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Reference will now be made to the accompanying drawings, which are not necessarily drawn to scale, and wherein:

FIG. 1 is a diagram that illustrates a network environment for determination of deviation in vehicle driving behavior and generating recommendations, in accordance with an embodiment of the disclosure;

FIG. 2 illustrates a block diagram of the apparatus of FIG. 1, in accordance with an embodiment of the disclosure;

FIG. 3A is a diagram that illustrates exemplary operations for determination of deviation in vehicle driving behavior and generating recommendations, in accordance with an embodiment of the disclosure;

FIG. 3B is a diagram that illustrates exemplary operations for determination of deviation in vehicle driving behavior and generating recommendations using machine learning, in accordance with an embodiment of the disclosure;

FIG. 4 is a diagram that illustrates exemplary operations for determination of deviation in vehicle driving behavior and generating recommendations for a scheduled driving session, in accordance with an embodiment of the disclosure;

FIG. 5 is a diagram that illustrates a first exemplary scenario for depicting the rendering of recommendations on a user interface, in accordance with an embodiment of the disclosure;

FIG. 6 is a diagram that illustrates a second exemplary scenario for depicting the rendering of recommendations, in accordance with an embodiment of the disclosure;

FIG. 7 is a diagram that illustrates a third exemplary scenario for depicting the rendering of recommendations on a user interface, in accordance with an embodiment of the disclosure;

FIG. 8 is a diagram that illustrates a fourth exemplary scenario for depicting the rendering of recommendations on a user interface, in accordance with an embodiment of the disclosure;

FIG. 9 is a diagram that illustrates a fifth exemplary scenario for depicting the rendering of recommendations on a user interface, in accordance with an embodiment of the disclosure;

FIG. 10 is a diagram that illustrates a sixth exemplary scenario for depicting the rendering of recommendations on a user interface for a scheduled driving session, in accordance with an embodiment of the disclosure;

FIG. 11 is a diagram of the map database, in accordance with an embodiment of the disclosure; and

FIG. 12 is a flowchart that illustrates an exemplary method for the determination of deviation in vehicle driving behavior and generating recommendations, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification does not necessarily all refer to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

The present disclosure may provide an apparatus, a method, and a computer programmable product for the determination of dynamic deviations in vehicle driving behavior and generating recommendations thereof. The disclosed apparatus provides techniques for determining a deviation in vehicle driving behavior and generates recommendations such that a driver of the vehicle may complete their usual commute within the available charge, thereby mitigating range anxiety. The apparatus may determine the deviation in the usage of the vehicle based on user profile data associated with a user (such as the driver) of the vehicle, and contextual information associated with a current driving session by the user. Further, the apparatus may be able to dynamically generate the recommendation associated with the modification in the driving range of the vehicle based on the determined deviation. The generation of the recommendation may be rendered on an infotainment unit of the vehicle to assist the user in understanding an impact of the deviation in the vehicle driving behavior on their usual commutes, thereby mitigating the range anxiety, and providing effective recommendations to make their commute within the available charge.

The disclosed apparatus may further communicate with a map database to update the deviation in the usage of the vehicle on a particular road in real time to generate optimal recommendations associated with the modification in the driving range of the vehicle. The disclosed apparatus may be able to predict a near-accurate driving range of electric vehicles based on the determined deviations. Specifically, the disclosed apparatus may compute the driving range while maintaining the usual commutes of the user. This may ensure that the driving range is close to an actual driving range (or accurate driving range) of the electric vehicle while traveling on the road. Moreover, the disclosed apparatus may be configured to notify the user of the vehicle about the recommendations, visually by displaying recommendations or generating audio alerts, such that the driver may be aware of the available driving range of the vehicle. The disclosed apparatus may communicate with a cruise control system of the vehicle to automatically maintain the driving range.

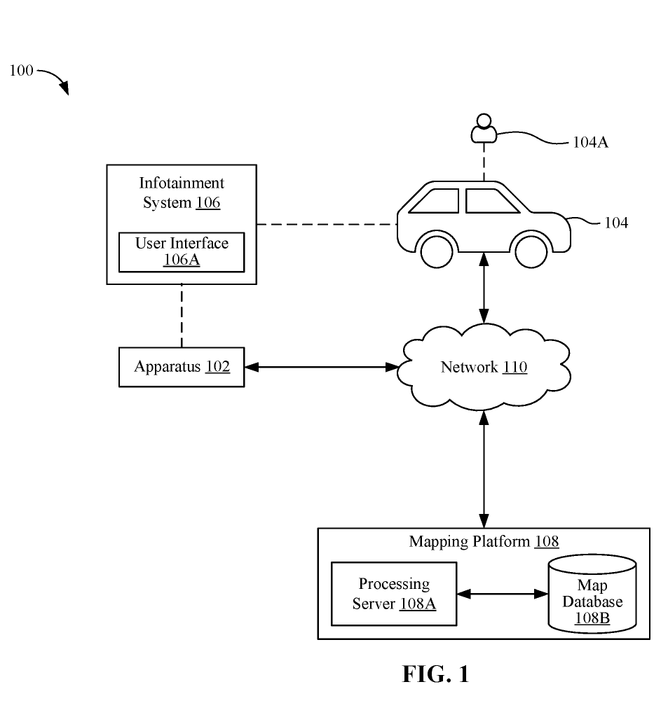

FIG. 1 is a diagram that illustrates a network environment for the determination of deviation in vehicle driving behavior and generating recommendations, in accordance with an embodiment of the disclosure. With reference to FIG. 1, there is shown a diagram of the network environment 100. The network environment 100 includes an apparatus 102, a vehicle 104, an infotainment system 106, and a mapping platform 108. The mapping platform 108 may include a processing server 108A and a map database 108B. The network environment 100 may further include a network 110. The infotainment system 106 may include a user interface (UI) 106A. In an embodiment, the apparatus 102 may be associated with the vehicle 104. In another embodiment, the apparatus 102 may be integrated within the vehicle 104.

The apparatus 102 may include suitable logic, circuitry, interfaces, and/or code that may be configured to determine deviation in vehicle driving behavior and generate recommendations thereof. Specifically, the apparatus 102 may be configured to generate recommendations based on the determination of the deviation in the vehicle driving behavior. In an embodiment, the apparatus 102 may be configured to retrieve user profile data associated with a user 104A of the vehicle 104. The apparatus 102 may further obtain first contextual information associated with a first driving session by the user 104A. Based on the retrieved user profile data and the obtained first contextual information, the apparatus 102 may be configured to determine a deviation associated with a usage of the vehicle 104. Thereafter, the apparatus 102 may be configured to generate a recommendation associated with a modification in a driving range of the vehicle 104 based on the determined deviation and provide, via the user interface 106A, the generated recommendation to the user 104A. Examples of the apparatus 102 may include, but are not limited to, an electronic control unit (ECU), an electronic control module (ECM), a computing device, a mainframe machine, a server, a computer workstation, any and/or any other device with deviation determination operations.

In an example embodiment, the apparatus 102 may be onboard the vehicle 104, such as the apparatus 102 may be a deviation determination system installed in the vehicle 104 for determining the deviation associated with the usage of the vehicle 104 or the vehicle driving behavior. In another example embodiment, the apparatus 102 may be the processing server 108A of the mapping platform 108 and therefore may be co-located with or within the mapping platform 108.

In another embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud. The OEM cloud may be configured to anonymize any data received by the apparatus 102, such as from the user profile data, before using the data for further processing, such as before sending the data to the map database 108B. For example, anonymization of the data may be done by the mapping platform 108.

The vehicle 104 may be a non-autonomous vehicle, a semi-autonomous vehicle, or a fully autonomous vehicle, for example, as defined by National Highway Traffic Safety Administration (NHTSA). Examples of the vehicle 104 may include, but are not limited to, a two-wheeler vehicle, a three-wheeler vehicle, a four-wheeler vehicle, more than a four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle 104 may be a system through which the user 104A (for example a driver) may travel from a starting point to a destination point. Examples of two-wheeler vehicles may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar-powered car, or a hybrid car. It may be noted here that the four-wheeler diagram of the vehicle 104 is merely shown as an example in FIG. 1. The present disclosure may also be applicable to other structures, designs, or shapes of the vehicle 104. The description of other types of vehicles and respective structures, designs, or shapes has been omitted from the disclosure for the sake of brevity.

In some example embodiments, the vehicle 104 may include processing means such as a central processing unit (CPU), storage means such as on-board read-only memory (ROM), and random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the vehicle 104. In some example embodiments, one or more user equipment may be associated, coupled, or otherwise integrated with the vehicles 104, such as an advanced driver assistance system (ADAS), a personal navigation device (PND), a portable navigation device, the infotainment system 106, and/or other devices that may be configured to provide route guidance and navigation-related functions to the user.

In some example embodiments, the vehicle 104 may generate sensor data associated with the vehicle 104 lane data, traffic data, and the like. In accordance with an embodiment, the sensor data may be generated by the vehicle 104, when one or more sensors on-board the vehicle 104 may sense information relating to, for example, contextual information associated with a driving session by the user 104A. In accordance with an embodiment, the vehicle 104 may generate the sensor data in real-time and transmit it to the apparatus 102 to determine the deviation. In certain cases, the vehicle 104 may be configured to send updated sensor data periodically, for example, every five seconds, every thirty seconds, every minute, and so forth.

For example, the user equipment may be installed in the vehicle 104 and may be configured to detect sensor data and contextual information associated with the driving session by the user 104A by using sensors installed in the corresponding vehicle. The user equipment may transmit the detected sensor data and the contextual information to the apparatus 102, which processes the detected data to determine the deviation in the vehicle driving behavior.

The infotainment system 106 may include suitable logic, circuitry, interfaces and/or code that may be configured to render at least audio-based data, or video-based data, on the user interface 106A in the vehicle 104. For example, the infotainment system 106 may include a display to display the user interface 106A on which the video-based data may be displayed. In another example, the infotainment system 106 may include a plurality of speakers to output the audio-based data. In such an example, the audio-based data may include, but is not limited to, audio content rendered on the plurality of speakers communicatively coupled to the user interface 106A. The infotainment system 106 may be configured to render the recommendation associated with the modification in the driving range of the vehicle on the user interface 106A. Examples of the infotainment system 106 may include, but are not limited to, an entertainment system, a navigation system, a vehicle user interface system, an Internet-enabled communication system, and other entertainment systems.

The mapping platform 108 may include suitable logic, circuitry, and interfaces that may be configured to store one or more map attributes and sensor data associated with traffic on link segments and lane segments. The mapping platform 108 may be configured to store and update map data indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some example embodiments, the mapping platform 108 may include the processing server 108A for carrying out the processing functions associated with the mapping platform 108 and the map database 108B for storing map data. In an embodiment, the processing server 108A may include one or more processors configured to process requests received from the apparatus 102. The processors may fetch sensor data and/or map data from the map database 108B and transmit the same to the apparatus 102 in a format suitable for use by the apparatus 102.

Continuing further, the map database 108B may include suitable logic, circuitry, and interfaces that may be configured to store the sensor data and map data, which may be collected from the vehicle 104 traveling on the road. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 108B of features within an environment that is appropriate for traffic-related services. In accordance with an embodiment, the sensor data may be collected from any sensor that may inform the mapping platform 108 or the map database 108B of features within an environment that is appropriate for mapping. For example, motion sensors, inertia sensors, image capture sensors, proximity sensors, LiDAR sensors, and ultrasonic sensors may be used to collect the sensor data. The gathering of large quantities of crowd-sourced data may facilitate the accurate modeling and mapping of an environment, whether it is a road link or a link within a structure, such as in an interior of a multi-level parking structure.

The map database 108B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data including the road topology and geometry-related attributes related to the road network from external systems, such as one or more background batch data services, streaming data services, and third-party service providers, via the network 110.

In accordance with an embodiment, the map data stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as an electronic device. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of the apparatus 102. In accordance with an embodiment, a client-side map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the subject vehicle 104) which use vehicle on-board sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 108B.

For example, the map database 108B may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some example embodiments, images received from image sources may be stored within the map database 108B of the mapping platform 108. In certain cases, the mapping platform 108, using the processing server 108A, may suitably process the received images. For example, such processing may include, suitably labeling the images based on corresponding associated lane and/or link, point of interest within the link and/or lane, and other information relating to the respective link and/or lane. Such labeled images may then be stored within the map database 108B as map data.

The apparatus 102 may be communicatively coupled to the vehicle 104, and the mapping platform 108, via the network 110. In an embodiment, the apparatus 102 may be communicatively coupled to other components not shown in FIG. 1 via the network 110. All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed.

The network 110 may be wired, wireless, or any combination of wired and wireless communication networks, such as cellular, Wi-Fi, internet, local area networks, or the like. In some embodiments, the network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The embodiments disclosed herein address the problems relating to determining the driving range based on a change in a usual vehicle driving behavior of the user 104A. The automotive industry may be making significant efforts to accurately predict the range of the electric vehicle by considering factors like weather, slope, climate control usage, acceleration pace, and the like. However, there are still certain limitations associated with the efforts of the automative industry. These shortcomings can lead to range anxiety among drivers of the vehicle. This may affect drivers’ confidence in adopting electric vehicles as a primary mode of transportation.

To overcome the above-mentioned problem, the apparatus 102 is disclosed. The disclosed apparatus 102 focuses on determining deviations from usual vehicle driving behavior, thereby understanding the impact of such deviations on the driving range of the vehicle 104. This dynamic approach may aim to assist the user 104A in planning their commute in an optimal manner based on the available battery charge level. Such accurate forecasting of the driving range of the vehicle 104 enhances convenience and usability for the user 104A.

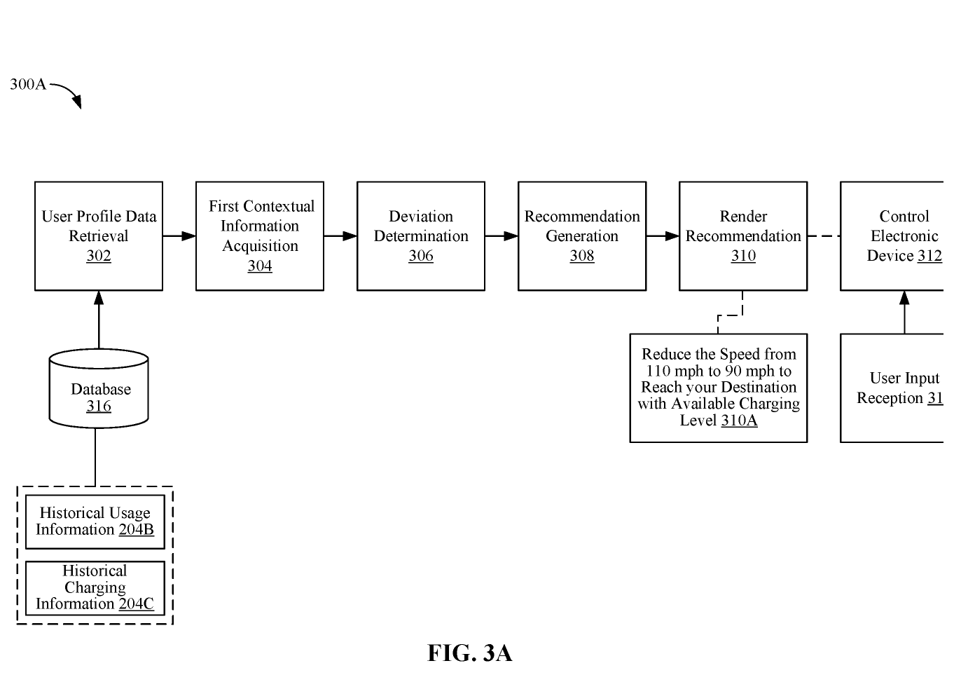

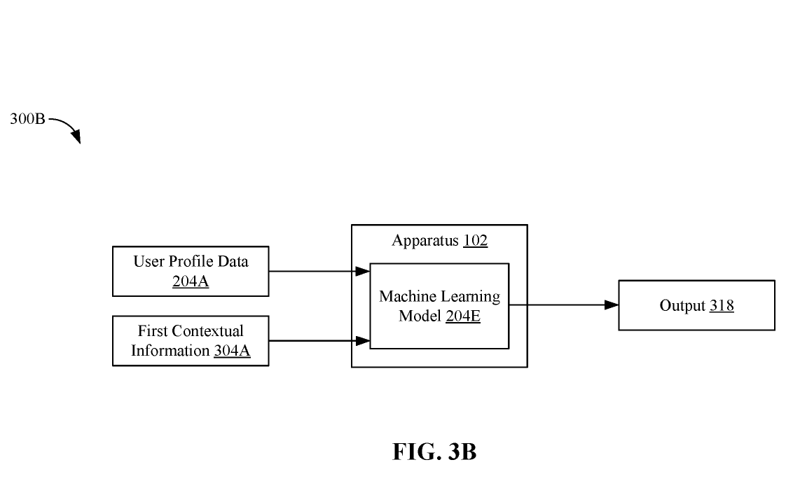

In operation, the apparatus 102 may be configured to retrieve the user profile data associated with the user 104A of the vehicle 104. The user profile data may include demographic information associated with the user 104A, preferences, and/or behavior associated with the usage of the vehicle 104. The user profile data includes historical usage information of the vehicle 104 during one or more historical driving sessions by the user 104A. The historical usage information of the vehicle 104 may refer to data associated with the historical usage pattern of the vehicle 104 during a past driving session by the user 104A. Such historical usage information of the vehicle 104 may include timestamp information associated with each driving session of the one or more historical driving sessions, route information associated with each driving session of the one or more historical driving sessions, weather information associated with a location of the vehicle 104 or a route be traversed by the vehicle 104 during each driving session of the one or more historical driving sessions, occupancy information associated with the vehicle 104 during each driving session of the one or more historical driving sessions, speed information associated with the vehicle during each driving session of the one or more historical driving sessions, vehicle information associated with the vehicle 104, or a combination thereof. Such historical usage information of the vehicle 104 may be employed to determine mobility patterns associated with the usage of vehicle 104. Details associated with the historical usage information of the vehicle 104 are provided, for example, in FIG. 3A.

In one scenario, the vehicle 104 is to an electric vehicle. In such a scenario, the user profile data may further include charging information associated with one or more historical charging sessions of the electric vehicle. The charging information associated with the one or more historical charging sessions of the electric vehicle may include timestamp information associated with each charging session of the one or more historical charging sessions, location information associated with each charging session of the one or more historical charging sessions, cost information associated with each charging session of the one or more historical charging sessions, or a combination thereof. Such charging information associated with the one or more historical charging sessions of the electric vehicle may be employed to determine charging patterns associated with the usage of vehicle 104, over time. Details associated with the charging information associated with the one or more historical charging sessions of the electric vehicle are provided, for example, in FIG. 3A. Such user profile data may be employed to personalize user experience and optimally determine the vehicle driving behavior based on their mobility and charge patterns.

In an embodiment, the apparatus 102 may be further configured to obtain first contextual information associated with a first driving session by the user 104A. The first contextual information associated with the vehicle 104 may include vehicle information associated with the vehicle 104 during the first driving session, charging information associated with the vehicle 104 during the first driving session, route information associated with the first driving session, traffic information associated with a route to be traversed by the vehicle 104 during the first driving session, weather information associated with a location of the vehicle 104 or the route to be traversed by the vehicle 104 during the first driving session, or a combination thereof. Such contextual information may be employed to determine contextual insights associated with a driving session by the user 104A, thereby providing information associated with vehicle driving behavior, the impact of various environmental factors on the driving session, vehicle dynamics, and the like. Details associated with the first contextual information are provided for example, in FIG. 3A.

Based on the user profile data, and the first contextual information, the apparatus 102 may be configured to determine a deviation associated with a usage of the vehicle 104. The deviation in the usage of the vehicle 104 during the first driving session may be determined based on one of a modification in vehicle health information associated with the vehicle 104, a modification in charge information associated with the vehicle 104, a modification in speed information associated with the vehicle 104, a modification in route information associated with the first driving session, a modification in traffic information associated with a route to be traversed by the vehicle 104, a modification in occupancy information associated with the vehicle 104 during the first driving session, environment information during the first driving session, or a combination thereof. Details associated with the determination of the deviation are provided, for example, in FIG. 3A.

The apparatus 102 may be configured to determine the deviation from usual vehicle driving behavior to help the user 104A understand the impact of the deviations on their mobility and charge patterns. Thereafter, the apparatus 102 may be configured to generate a recommendation associated with a modification in a driving range of the vehicle 104 based on the determined deviation and provide the generated recommendation on the user interface 106A. In an embodiment, the generated recommendation may be provided as an option for selection by the user 104A. The apparatus 102 may be configured to generate the recommendations in a manner that the user 104A may maintain their usual mobility and charging patterns despite the deviation, if selected (or followed) by the user 104A. Details associated with the generation of the recommendations are provided, for example, in FIG. 3A.

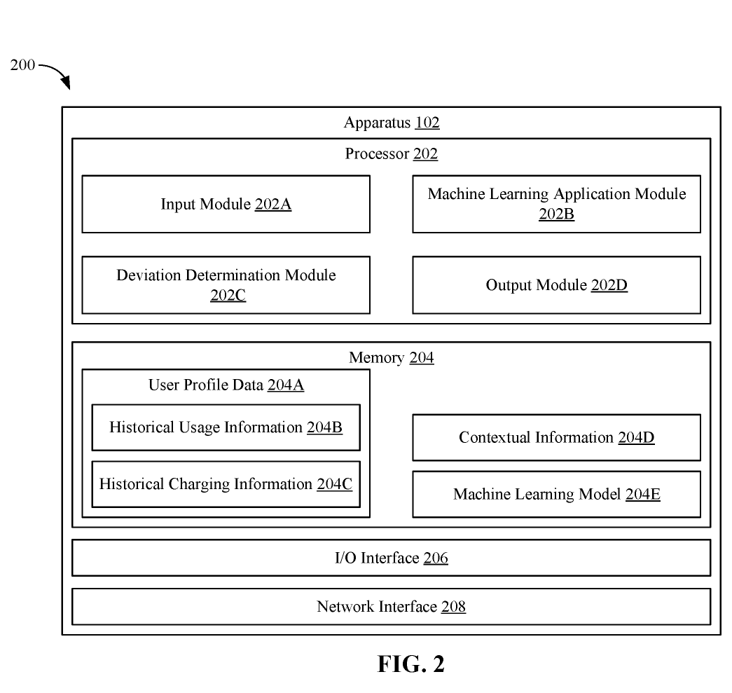

FIG. 2 illustrates a block diagram 200 of the apparatus of FIG. 1, in accordance with an embodiment of the disclosure. FIG. 2 is explained in conjunction with FIG. 1. In FIG. 2, there is shown the block diagram 200 of the apparatus 102. The apparatus 102 may include at least one processor 202 (referred to as a processor 202, hereinafter), at least one non-transitory memory 204 (referred to as a memory 204, hereinafter), an input/output (I/O) interface 206, and a network interface 208. The processor 202 may comprise modules, depicted as, an input module 202A, a machine learning application module 202B, a deviation determination module 202C, and an output module 202D. The processor 202 may be connected to the memory 204, and the I/O interface 206 through wired or wireless connections. Although in FIG. 2, it is shown that the apparatus 102 includes the processor 202, the memory 204, and the I/O interface 206 however, the disclosure may not be so limiting and the apparatus 102 may include fewer or more components to perform the same or other functions of the apparatus 102. In an embodiment, the input module 202A, and the output module 202D may be integrated within the I/O interface 206. In some embodiments, the input module 202A may receive input data (such as user inputs), and the output module 202D may output processed data (such as the recommendations) via the I/O interface 206.

In accordance with an embodiment, the apparatus 102 may store data that may be generated by the modules while performing corresponding operations or may be retrieved from a database associated with the apparatus 102, such as the map database 108B, in the memory 204. For example, the data may include vehicle information, traffic information, user information, distance information, and environmental information.

The processor 202 of the apparatus 102 may be configured to determine deviation in vehicle driving behavior and generate recommendations associated with a modification in the driving range of the vehicle 104 and further output the generated recommendation. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the network interface 208 of the apparatus 102. The network interface 208 may provide an interface for accessing various features and data stored in the apparatus 102.

In some embodiments, the processor 202 may be configured to provide Internet-of-Things (IoT) related capabilities to users of the apparatus 102 disclosed herein. The IoT-related capabilities may in turn be used to provide smart city solutions by providing real-time vehicle driving behavior, real-time recommendations, big data analysis, and sensor-based data collection by using the cloud-based mapping system for providing accurate navigation instructions and ensuring completion of the commute within the available driving range. The I/O interface 206 may provide an interface for accessing various features and data stored in the apparatus 102.

The input module 202A of the processor 202 may be configured to retrieve the user profile data and the contextual information associated with the first driving session. In an embodiment, the contextual information may be obtained from the one or more sensors associated with the vehicle 104. For example, the one or more sensors may include one or more image sensors, one or more LIDARs, one or more speed sensors, one or more global positioning sensors (GPS), and the like.

The machine learning application module 202B of the processor 202 may be configured to apply a machine learning model on the user profile data and the contextual information. The user profile data may be associated with usual mobility and charge patterns associated with vehicle 104. The contextual information associated with the vehicle 104 may include but is not limited to vehicle information associated with the vehicle 104 during the first driving session, charging information associated with the vehicle 104 during the first driving session, route information associated with the first driving session, traffic information associated with a route to be traversed by the vehicle 104 during the first driving session, weather information associated with a location of the vehicle or the route to be traversed by the vehicle during the first driving session, or a combination thereof.

The deviation determination module 202C of the processor 202 may be configured to determine the deviation associated with the usage of the vehicle 104. In an embodiment, the deviation determination module 202C may determine the deviation based on retrieved user profile data and the obtained first contextual information. In another embodiment, the deviation determination module 202C may determine the deviation based on an output of the machine learning model. The deviation determination module 202C of the processor 202 may be further configured to determine the deviation in vehicle driving behavior.

The output module 202D of the processor 202 may be configured to output the recommendation associated with the modification in the driving range of the vehicle 104. In an embodiment, the output module 202D may be configured to render the recommendation on the user interface 106A. The output module 202D may be further configured to output the generated recommendations on the infotainment system 106 of the vehicle 104. In another embodiment, the output module 202D of the processor 202 may be configured to transmit the recommendation to the map database 108B. In another embodiment, the output module 202D of the processor 202 may be configured to control the maneuver of the vehicle 104 in order to maintain the driving range of the vehicle.

The memory 204 of the apparatus 102 may be configured to store user profile data 204A, historical usage information 204B, historical charging information 204C, and contextual information 204D. The contextual information 204D may include a first contextual information associated with a first driving session by the user 104A, and a second contextual information associated with the scheduled driving session by the user 104A. The memory 204 of the apparatus 102 may be further configured to store a navigation route, a user request, a driving range, a likelihood value, and the like. The memory 204 may be further configured to store a training sample. In an embodiment, the memory 204 may be configured to store the machine learning model 204E. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In an embodiment, the processor 202 may be configured to train the machine learning model 204E based on the retrieved user profile data 204A and the obtained first contextual information 204D, and store the machine learning model 204E in the memory 204. In an exemplary embodiment, the machine learning model 204E may be used for various tasks such as, but not limited to, classification, regression, pattern recognition, and decision-making.

In an embodiment, the machine learning model 204E may correspond to a neural network-based classifier. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on a training dataset. Each node of the neural network may correspond to a mathematical function (e.g., a sigmoid function or a rectified linear unit) with a set of parameters, tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In the training of the neural network, one or more parameters of each node of the neural network may be updated based on whether an output of the final layer for a given input (from a training dataset) matches a correct result based on a loss function for the neural network. The above process may be repeated for the same or a different input until a minimum loss function may be achieved, and a training error may be minimized. Several methods for training are known in the art, for example, gradient descent, stochastic gradient descent, batch gradient descent, gradient boost, meta-heuristics, and the like.

The neural network may include electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Although in FIG. 2, the machine learning model 204E is shown integrated within the apparatus 102, the disclosure is not so limited. Accordingly, in some embodiments, the machine learning model 204E may be a separate entity in the apparatus 102, without deviation from the scope of the disclosure. Examples of the machine learning model 204E may include, but are not limited to, an artificial neural network (ANN), a deep neural network (DNN), a convolutional neural network (CNN), a fully connected neural network, and/or a combination of such networks. Details about the machine learning model 204E are provided, for example, in FIG. 3B.

In some example embodiments, the I/O interface 206 may communicate with the apparatus 102 and display the input and/or output of the apparatus 102. As such, the I/O interface 206 (for example, the infotainment system 106) may include a display and, in some embodiments, may also include a keyboard, a mouse, a joystick, a touch screen, touch areas, soft keys, one or more microphones, a plurality of speakers, or other input/output mechanisms. In one embodiment, the apparatus 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on the memory 204 accessible to the processor 202. The processor 202 may further render recommendations associated with the associated with the modification in the driving range of the vehicle, on a user device or audio or display onboard the vehicles via the I/O interface 206.

The network interface 208 may comprise an input interface and output interface for supporting communications to and from the apparatus 102 or any other component with which the apparatus 102 may communicate. The network interface 208 may be any means such as a device or circuitry embodied in either hardware or a combination of hardware and software that is configured to receive and/or transmit data to/from a communications device in communication with the apparatus 102. In this regard, the network interface 208 may include, for example, an antenna (or multiple antennae) and supporting hardware and/or software for enabling communications with a wireless communication network. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms. In some embodiments, the network interface 208 may enable communication with a cloud-based network to enable deep learning, such as using the machine learning model 204E (that may be hosted on the cloud-based network).

FIG. 3A is a diagram that illustrates exemplary operations for the determination of deviation in vehicle driving behavior and generating recommendations, in accordance with an embodiment of the disclosure. FIG. 3A is explained in conjunction with elements from FIG. 1 and FIG. 2. With reference to FIG. 3A, there is shown the block diagram 300A that illustrates exemplary operations from 302 to 314, as described herein. The exemplary operations illustrated in the block 300A may start at 302 and may be performed by any computing system, apparatus, or device, such as the apparatus 102 of FIG. 1 or the processor 202 of FIG. 2. Although illustrated with discrete blocks. The exemplary operations associated with one or more blocks of the block diagram 300A may be divided into additional blocks, combined into fewer blocks, or eliminated, depending on the particular implementation.

At 302, user profile data may be retrieved. In an embodiment, a processor 202 may be configured to retrieve the user profile data 204A associated with the user 104A of the vehicle 104. The user profile data 204A may be stored on a database 316 associated with the apparatus 102. Further, the user profile data 204A may provide insights to determine the mobility and charge patterns of the vehicle 104. In an embodiment, the user profile data 204A may include the historical usage information 204B of the vehicle 104 during one or more historical driving sessions by the user 104A. The historical usage information 204B of the vehicle may include, but is not limited to timestamp information associated with each driving session of the one or more historical driving sessions, route information associated with each driving session of the one or more historical driving sessions, weather information associated with a location of the vehicle or a route traversed by the vehicle during each driving session of the one or more historical driving sessions, occupancy information associated with the vehicle during each driving session of the one or more historical driving sessions, speed information associated with the vehicle during each driving session of the one or more historical driving sessions, vehicle information associated with the vehicle, or a combination thereof.

The timestamp information associated with each driving session of the one or more historical driving sessions may include, but is not limited to information associated with the time of the driving session (or commute time), a time of the day (such as morning, evening, or night) of the driving session, or a duration of the driving session. The route information associated with each driving session of the one or more historical driving sessions may include, but is not limited to, routing information such as a source location and a destination location associated with the driving session, a route to be traversed by the user 104A of the vehicle 104 during the driving session. The weather information associated with a location of the vehicle 104 or a route be traversed by the vehicle 104 during each driving session of the one or more historical driving sessions may include, but not limited to, environmental conditions such as temperature, humidity, precipitation, wind speed, and the like. The occupancy information associated with the vehicle during each driving session of the one or more historical driving sessions may include, but is not limited to, a number of people present in the vehicle 104 during the driving session. The speed information associated with the vehicle 104 during each driving session of the one or more historical driving sessions may include, but is not limited to, acceleration or deacceleration information of the vehicle, and an intensity of brakes applied during the driving session. The vehicle information associated with the vehicle 104 may include, but is not limited to, the health status of the vehicle 104 and one or more parameters associated with one or more electronic devices associated with the vehicle 104. The one or more electronic devices associated with the vehicle may include, but are not limited to, a Heating, Ventilation, and Air Conditioning system, an infotainment system, an on-board diagnostics system, a Tire Pressure Monitoring System, a Battery Management System, a vehicle control unit, a navigation system, and an Advanced Driver Assistance System.

The Heating, Ventilation, and Air Conditioning system may include suitable logic, circuitry, and/or interfaces, that may be configured to provide an in-vehicle environmental comfort by controlling temperature, humidity, and air quality in the vehicle 104. The infotainment system 106 may include suitable logic, circuitry, and/or interfaces, that may be configured to provide information and entertainment features into a single interface (such as the user interface 106A). The infotainment system 106 may include functions that may include, but are not limited to navigation, audio-video playback, and vehicle diagnostics. The on-board diagnostics system may include suitable logic, circuitry, and/or interfaces that may be configured to provide on-board diagnostics data associated with the vehicle 104. The on-board diagnostics data may include but not be limited to engine load parameters, rotation per minute data, vehicle break data, and information related to service time and wear and tear associated with vehicle 104. The Tire Pressure Monitoring System may include suitable logic, circuitry, and/or interfaces that may be configured to analyze air metering data to determine tire pressure. The Battery Management System may include suitable logic, circuitry, and/or interfaces that may be configured to analyze battery metering data to determine available charging.

In an embodiment, the vehicle 104 may correspond to an electric vehicle. In an embodiment, the user profile data 204A may further include historical charging information 204C associated with one or more historical charging sessions of the electric vehicle. The historical charging information 204C associated with the one or more historical charging sessions of the electric vehicle may include, but is not limited to, timestamp information associated with each charging session of the one or more historical charging sessions, location information associated with each charging session of the one or more historical charging sessions, cost information associated with each charging session of the one or more historical charging sessions, or a combination thereof. The timestamp information may include, but is not limited to, information associated with a time of the charging session, a time of day associated with the charging session, and a duration of the charging session. The location information may include, but is not limited to, information associated with the location of the charging session. For example, the location where the user 104A may charge the vehicle 104 such as at work, at an airport, at the shopping center, at the charging station, and the like. The cost information may correspond to a price being paid for the charging of the vehicle 104. For example, the user 104A may charge the electric vehicle for free in a parking lot of a shopping complex or gym while visiting respective places.

In an embodiment, the processor 202 may be configured to employ the user profile data 204A to establish a usage pattern of the vehicle 104 by the user 104A. Such usage patterns may act as a baseline for a personal setting associated with the driving range, thereby making a user centric prediction for the electric vehicle range in contrast to the existing technological based forecast. For an example, the historical usage information 204B for a given duration such as for the past 6 months may be employed to determine the vehicle driving behavior of the user 104A. The given duration may vary without any deviation from the scope of the disclosure. Further, based on the user profile data 204A, the processor 202 may be configured to determine the mobility and charge patterns, one or more activities performed by the user 104A while the vehicle 104 is being charged, and the like. The one or more activities may include, but are not limited to, picking up kids from school, going out shopping, visiting parents, sports, or other leisure activities.

In an embodiment, the processor 202 may be configured to determine deviation in the user profile data 204A over a period of time. Further, the processor 202 may be configured to update the user profile data 204A based on the determined deviation. For example, the user 104A may have started a new job, this may result in a change in the mobility pattern of the user or the charging pattern of a vehicle associated with the user 104A. Therefore, the processor 202 may be configured to update the user profile data 204A and determine a new baseline for the personal setting associated with the driving range. For example, for a given activity, the charging levels of the vehicle 104 may be monitored and stored in the map database 108B or the database 316. For example, when the user 104A goes to the gym on a Tuesday night, the electric vehicle charging level is usually between 65%-70%. Further, the mobility pattern or usage information (such as speed, number of people in the vehicle 104, driving style, and the like) may be stored, for each route segment, over the database 316. In such an example, the user 104A may also have a weekday user profile and a weekend user profile. The weekday user profile may include data associated with driving from the office to home and vice-versa, whereas the weekend user profile may include data associated with driving to the gym or other leisure activities. Further, the processor 202 may utilize the user profile data 204A to generate multiple profiles of the user (such as highway versus city, weekday versus weekends, and the like).

At 304, first contextual information may be acquired. In an embodiment, the processor 202 may be configured to obtain (or acquire) the first contextual information associated with a first driving session by the user 104A. The first contextual information associated with the first driving session of the vehicle 104 by the user 104A may include, but is not limited to, vehicle information associated with the vehicle 104 during the first driving session, charging information associated with the vehicle 104 during the first driving session, route information associated with the first driving session, traffic information associated with a route to be traversed by the vehicle 104 during the first driving session, weather information associated with a location of the vehicle 104 or the route to be traversed by the vehicle 104 during the first driving session, or a combination thereof. The first contextual information associated with the first driving session may correspond to contextual insights associated with a current driving session of the user 104A. The processor 202 may be configured to determine a current driving behavior based on the first contextual information associated with the current driving session.

Thereafter, the processor 202 may be configured to compare a historical driving behavior for a given activity (such as going to school at 8 am, Monday morning) with a current driving behavior for the given activity. Further, a deviation associated with the usage of the vehicle 104 may be determined based on the comparison.

At 306, a deviation may be determined. In an embodiment, the processor 202 may be configured to determine the deviation associated with the usage of the vehicle 104 based on the retrieved user profile data 204A and the obtained first contextual information. The deviation in the usage of the vehicle 104 during the first driving session may be determined based on one of a modification in vehicle health information associated with the vehicle 104, a modification in charge information associated with the vehicle 104, a modification in speed information associated with the vehicle 104, a modification in route information associated with the first driving session, a modification in traffic information associated with a route to be traversed by the vehicle 104, a modification in occupancy information associated with the vehicle 104 during the first driving session, environment information during the first driving session, or a combination thereof.

The modification in the vehicle health information associated with the vehicle 104 may include, but not be limited to, a deviation in tire pressure, such as the tire pressure being low as compared to the usual tire pressure for the first driving session. The modification in charge information associated with the vehicle 104 may include, but is not limited to, a deviation in the available charging level of the battery of the vehicle 104, for example, the charging level may be low or high as compared to the usual charge availability. The modification in speed information associated with the vehicle 104 may include, but is not limited to, a deviation in speed, for example, acceleration or deacceleration of the vehicle 104 may be different as compared to the usual speed for the first driving session. The modification in route information associated with the first driving session may include, but is not limited to, a change in a route or a topology of the route being traversed by the vehicle 104, for example, driving on hilly terrain as compared to usual flat terrain. In another example, the modification in the route information may correspond to a deviation in road surface conditions such as a change in traction. The modification in traffic information associated with a route to be traversed by the vehicle 104 may include, but is not limited to, a change in traffic conditions on the route being traversed by vehicle 104 for the driving session, for example, applying the bakes more than usual or making more stops because of the traffic conditions in real-time.

The modification in occupancy information associated with the vehicle 104 during the first driving session may include, but is not limited to, a change in occupancy of the vehicle 104 during the driving session, for example, usually 3 people travel to the office in the vehicle during a trip to the gym on a Wednesday evening but for the current driving session only 1 person is present. The deviation may also be determined based on a change in weightage information, for example the vehicle may be employed for cargo or towing. The modification of environmental information during the first driving session may include, but is not limited to, a change in weather conditions, for example, the temperature may be colder or hotter than usual. Further, the deviation may also be determined based on a modification of the time of the day, for example, the user 104A may visit the sports complex on Thursday evening in contrast to his usual trip made on Friday evening. Such a deviation in the usage of the vehicle may result in a loss of range.

The processor 202 may be configured to determine the impact of such deviations on the vehicle driving behavior. For example, the impact of such deviations may correspond to one of a positive impact or a negative impact on the driving range of vehicle 104. In an embodiment, if a deviation in the vehicle driving behavior results in improvement or enhancement of the driving range of the vehicle 104, then such impact may correspond to a positive impact. In another example, if the deviation in the vehicle driving behavior results in a loss of the driving range of the vehicle 104, then such impact may correspond to a negative impact.

Based on the type of impact of the deviation, the processor 202 may be configured to generate recommendations associated with the driving range of the vehicle 104 to maintain the usual mobility and/or charge patterns associated with the vehicle 104. In other words, the processor 202 may be configured to generate the recommendation to notify the user 104A about which changes could be made in the vehicle driving behavior without impacting the usual activities.

At 308, a recommendation may be generated. In an embodiment, the processor 202 may be configured to generate the recommendation associated with a modification in a driving range of the vehicle 104 based on the determined deviation. The generated recommendation associated with the modification in the driving range of the vehicle may correspond, but is not limited to, a modification in a speed associated with the vehicle 104, a modification in charge information associated with the vehicle 104, a modification in vehicle health information associated with the vehicle 104, a modification in a route to be traversed by the vehicle 104, a modification in one or more parameters of one or more electronic devices associated with the vehicle 104, a modification in a start time associated with the first driving session, or a combination thereof.

For example, the recommendation may correspond to a change in the speed of the vehicle 104. In another example, the recommendation may correspond to a change in time of departure. In yet another example, the recommendation may correspond to a change in the route taken for the first driving session. For example, the recommendation may correspond to increasing or decreasing parameters of the one or more electronic devices such as the Heating, Ventilation, and Air Conditioning system to change the air conditioning or heating usage in the vehicle 104. In another example, the recommendation may correspond to the maintenance of the vehicle 104.

By way of an example and not limitation, the processor 202 may determine the deviation associated with the speed information. The deviation may correspond to an increase in speed on the highway during the first driving session. Such deviation might have a positive impact on the driver, as his time of arrival on the destination may decrease by 20 minutes, however, this may have a negative impact on the driving range as the user 104A may have to make an extra charge than his usual charging pattern to maintain their usual commute. Therefore, the processor 202 may generate the recommendation notifying the user 104A for example, “You are now driving at 140 miles per hour (mph) or kilometers per hour (kmph) on this highway while going to work in the morning, in contrast to a speed of 110 mph during the last few months. This may save you 20 minutes per day on your commute, but you will have to make one extra charge on Thursday, if you want to be able to visit the gym at the weekend as you normally do."

By way of another example and not limitation, the recommendation may correspond to “If you reduce your speed on the highway by 10 mph on your commute, this will save you one charge per week, Therefore, you may avoid the charging session on Wednesday to complete the charge, and instead go to the gym." This way, the user 104A may be made aware of the pattern change and the consequences of such deviations. In other words, the user 104A may be notified by the constraints linked to the provided driving range, thereby dynamically updating the driving range estimation. In yet another example, the recommendation may correspond to "If you wish, you may increase your speed by 10 mph on your commute to work with your usual charging patterns or mobility patterns.”

At 310, the recommendation may be provided. In an embodiment, the processor 202 may be configured to provide, via the user interface 106A, the generated recommendation. The user interface 106A may be displayed on at least one of the infotainment system 106 associated with the vehicle 104, or a user device associated with the user 104A of the vehicle 104. In an embodiment, the processor 202 may be configured to provide the generated recommendation as an option for selection by the user 104A. The processor 202 may be configured to receive a user input to select the generated recommendation. The user input may correspond to, but is not limited to, a touch input, a tactile input, an audio input, or a gesture. For example, the generated recommendations may be displayed on a display screen associated with the infotainment system 106 or the user device (such as a mobile phone). In another example, the user 104A may be notified by using an audio signal, thereby rendering the recommendation via a set of speakers associated with the infotainment system 106 or the user device. As shown at 310A, the rendered recommendation may correspond to “reduce the speed from 110 mph to 90 mph to reach your destination with available charging level.”

At 312, electronic devices associated with the vehicle may be controlled. In an embodiment, the processor 202 may be configured to control one or more parameters of one or more electronic devices associated with the vehicle based on the selection of the generated recommendation. For example, the processor 202 may be configured to the control one or more parameters of one or more electronic devices associated with the vehicle 104 automatically based on the generated recommendation. For example, an intensity of the volume associated with the infotainment system 106 may be increased or decreased based on the generated recommendation. In another example, the intensity of heat or cooling may be increased or decreased based on the generated recommendation to maintain the driving range.

At 314, a user input may be received. In an embodiment, the processor 202 may be configured to receive the user input associated with a modification in the one or more parameters of the one or more electronic devices associated with the vehicle 104 based on the generated recommendation. Further, the processor 202 may be configured to control the one or more parameters of the one or more electronic devices associated with the vehicle based on the received user input. For example, the user input may correspond to, but is not limited to a touch input, a verbal input, a gesture, and the like. The user input may indicate the modification to be done based on the generated recommendation. For example, if the recommendation corresponds to reducing the speed, the user input may correspond to stepping away from the paddle to decelerate. In another example, the user input may be an audio input that may be captured by a microphone associated with the infotainment system 106 to decrease the temperature of the Heating, Ventilation, and Air Conditioning system. In yet another example, the recommendation may correspond to asking the user 104A to platoon behind a truck or a large SUV, thereby enabling the user 104A to reach the destination on a given limited range.

The apparatus 102 may predict the optimal impact of the deviation in the vehicle driving behavior on their regular commute. Therefore, the proposed apparatus 102 may allow the electric vehicle driver to benefit from contextual insights associated with the usage pattern of the vehicle 104, thereby helping the user 104A to understand possible impacts on their mobility and charge patterns by determining deviations from the usual vehicle driving behavior.

In an embodiment, the processor 202 may be configured to receive a user input associated with the modification in the driving range of the vehicle 104. Thereafter, the processor 202 may be configured to generate the recommendation associated with the modification in the driving range of the vehicle 104 based on the received user input. For example, the user input may be indicative of an activity to be completed or a destination to be reached, such as the user 104A may provide the user input to optimize car and driving parameters to accomplish the activity or reach a particular destination. Thereafter, the processor 202 may be configured to generate the recommendations to complete the activity while maintaining the driving range. In an example, the processor 202 may be configured to recommend a speed limit or an optimal speed at which the user 104A may drive to complete the activity whilst maintaining the driving range of the electric vehicle. In another example, the user input may be a request such as “I know I might be missing a little bit of range, but I need to reach this place, so please adapt the needed parameters for me or let me know what I should do”. In such an example, the processor 202 may be configured to automatically control the Heating, Ventilation, and Air Conditioning system (or the climate control unit) and other non-critical IVI features (such as dimming the screen, music, etc.).

FIG. 3B is a diagram that illustrates exemplary operations for the determination of deviation in vehicle driving behavior and generating recommendations using machine learning, in accordance with an embodiment of the disclosure. FIG. 3B is explained in conjunction with elements from FIG. 1, FIG. 2, and FIG. 3A. With reference to FIG. 3B, there is shown the block diagram 300B of the apparatus 102 that includes the machine learning model 204E. There is further shown user profile data 204A, first contextual information 304A, and output 318. In an embodiment, the processor 202 may be configured to apply the machine learning model 204E on the retrieved user profile data 204A and the obtained first contextual information 304A.

The machine learning model 204E may be trained to identify a relationship between inputs, such as retrieved user profile data 204A and the obtained first contextual information 304A in a training dataset, and output a likelihood value indicative of the deviation in the usage of the vehicle 104. The machine learning model 204E may be defined by its hyper-parameters, for example, a number of weights, cost function, input size, number of layers, and the like. The hyper-parameters of the machine learning model 204E may be tuned and weights may be updated to move towards a global minimum of a cost function. After several epochs of the training on the feature information in the training dataset, the machine learning model 204E may be trained to output a prediction result for a set of inputs. The prediction result may be indicative of the deviation in the usage of the vehicle 104.

The machine learning model 204E may include electronic data, such as, for example, a software program, code of the software program, libraries, applications, scripts, or other logic or instructions for execution by a processing device, such as the apparatus 102. The machine learning model 204E may include code and routines configured to enable a computing device, such as the apparatus 102 to perform one or more operations for determination of deviations in the vehicle driving behavior. Additionally, or alternatively, the machine learning model 204E may be implemented using hardware including a processor, a microprocessor (e.g., to perform or control the performance of one or more operations), a field-programmable gate array (FPGA), or an application-specific integrated circuit (ASIC). Alternatively, in some embodiments, the machine learning model 204E may be implemented using a combination of hardware and software. Examples of the machine learning model 204E may include, but are not limited to, a Deep Neural Network (DNN), an Artificial Neural Network (ANN), Long Short-Term Memory (LSTM) network (ANN-LSTM), a Convolutional Neural Network (CNN), a CNN-Recurrent Neural Network (RNN), a Connectionist Temporal Classification (CTC) model, or a Hidden Markov Model.

The machine learning model 204E may be configured to analyze the retrieved user profile data 204A and the obtained first contextual information 304A to determine the vehicle driving behavior. The machine learning model 204E may be trained on the historical usage information 204B and the historical charging information 204C to determine improved vehicle driving behavior through contextual or regular optimizations. Thereafter, the machine learning model 204E may be configured to generate the output 318 indicative of the deviation in the usage of the vehicle 104. Further, the processor 202 may be configured to generate the recommendation associated with the modification in the driving range of the vehicle based on the output 318 of the machine learning model 204E.

Further, the apparatus 102 may leverage the use of machine learning model 204E to maintain their mobility and/or charging patterns and generate optimal recommendations associated with the driving range of the vehicle 104. The machine learning model 204E may dynamically update the range estimation based on the determined deviation in the vehicle driving behavior, thereby providing optimal recommendations.

In an embodiment, the processor 202 of FIG. 2 may be configured to determine one or more missing values associated with the first contextual information 304A associated with the first driving session, thereby resulting in inaccurate predictions. In such a scenario, the machine learning model 204E may be configured to generate an alert for the user 104A to obtain the one or more missing values, thereby gathering more data points for a given set of circumstances/context and performing a complete analysis of the mobility patterns. For example, the alert may correspond to a notification message indicative of a change in the vehicle driving behavior, such as asking the user 104A to drive 10 mph slower on a particular section of road on a particular day.

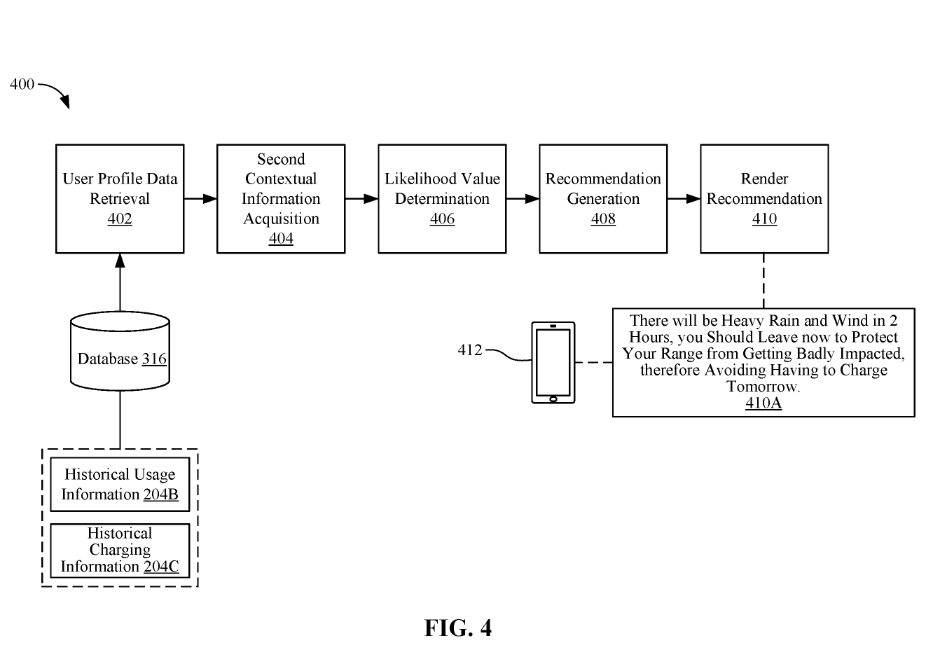

FIG. 4 is a diagram that illustrates exemplary operations for the determination of deviation in vehicle driving behavior and generating recommendations for a scheduled driving session, in accordance with an embodiment of the disclosure. FIG. 4 is explained in conjunction with elements from FIG. 1, FIG. 2, FIG. 3A and FIG. 3B. With reference to FIG. 4, there is shown the block diagram 400 that illustrates exemplary operations from 402 to 410, as described herein. The exemplary operations illustrated in the block 400 may start at 402 and may be performed by any computing system, apparatus, or device, such as the apparatus 102 of FIG. 1 or the processor 202 of FIG. 2. Although illustrated with discrete blocks. The exemplary operations associated with one or more blocks of the block diagram 400 may be divided into additional blocks, combined into fewer blocks, or eliminated, depending on the particular implementation.

At 402, user profile data 204A may be retrieved. In an embodiment, the processor 202 may be configured to retrieve the user profile data 204A associated with the user 104A of the vehicle 104. The user profile data 204A comprises historical usage information 204B of the vehicle 104 during one or more historical driving sessions by the user 104A. The historical usage information 204B of the vehicle 104 may include, but is not limited to, timestamp information associated with each driving session of the one or more historical driving sessions, route information associated with each driving session of the one or more historical driving sessions, weather information associated with a location of the vehicle 104 or a route to be traversed by the vehicle 104 during each driving session of the one or more historical driving sessions, occupancy information associated with the vehicle during each driving session of the one or more historical driving sessions, speed information associated with the vehicle 104 during each driving session of the one or more historical driving sessions, vehicle information associated with the vehicle 104, or a combination thereof, as described for example, in FIG. 3A.

In an embodiment, the vehicle 104 may correspond to an electric vehicle. The user profile data 204A may further include the historical charging information 204C associated with one or more historical charging sessions of the electric vehicle. The historical charging information 204C associated with the one or more historical charging sessions of the electric vehicle may include, but not limited to, timestamp information associated with each charging session of the one or more historical charging sessions, location information associated with each charging session of the one or more historical charging sessions, cost information associated with each charging session of the one or more historical charging sessions or a combination thereof, as described for example, in FIG. 3A.

In an embodiment, the first driving session may correspond to a scheduled driving session. The scheduled driving session may correspond to the pre-planned driving session by the user 104A (such as going to the gym in the evening). In an example, the processor 202 may be configured to determine the scheduled driving session based on the retrieved user profile data 204A. In another example, the user 104A may plan the driving session.

At 404, second contextual information may be acquired. In an embodiment, the processor 202 may be configured to acquire (or obtain) the second contextual information associated with the scheduled driving session by the user 104A. The second contextual information associated with the vehicle 104 may include, but is not limited to, vehicle information associated with the vehicle for the scheduled driving session, the charging information associated with the vehicle 104 for the scheduled driving session, route information associated with the scheduled driving session, traffic information associated with a route to be traversed by the vehicle 104 during the scheduled driving session, weather information associated with a location of the vehicle 104, or the route to be traversed by the vehicle 104 during the scheduled driving session, or a combination thereof, as described for example, in FIG. 3A.

At 406, a likelihood value may be determined. In an embodiment, the processor 202 may be configured to determine the likelihood value indicative of the deviation in the usage of the vehicle based on the retrieved user profile data 204A and the obtained second contextual information. In another embodiment, the machine learning model 204E may be configured to output the likelihood value indicative of the deviation in the usage of the vehicle based on the retrieved user profile data 204A and the obtained second contextual information. The likelihood value indicative of the deviation may correspond to the possibility of the occurrence of the deviation based on the user profile data 204A and the second contextual information.

At 408, a recommendation may be generated. In an embodiment, the processor 202 may be configured to generate the recommendation associated with the modification in the driving range of the vehicle based on the determined likelihood value. In another embodiment, the processor 202 may be configured to generate the recommendation associated with the modification in the driving range of the vehicle based on the output 318 of the machine learning model 204E.

For example, the machine learning model 204E may analyze the user profile data 204A and the second contextual information, thereby generating the output indicative of the modification in the weather information. Thereafter, the processor 202 may be configured to generate the recommendation based on the output 318 of the machine learning model 204E.

By way of example and not limitation, the recommendation may correspond to a notification on the user device for the scheduled driving session such as “there will be heavy rain and wind in 2 hours, so you should rather leave now in order not to protect your range from getting badly impacted and therefore avoiding charging tomorrow.” As another example, the recommendation may correspond to a notification for the scheduled driving session such as, “In the next 2 weeks, there might be a temperature drop of 10 degrees, this may impact your traveling schedule next week, consider leaving early and drive slow than usual commute speed to maintain your charging pattern.”

At 410, the recommendation may be rendered. In an embodiment, the processor 202 may be configured to render the generated recommendation on the user interface 106A, as an option for selection by the user 104A. The user interface 106A may be displayed on a user device 412 associated with the user 104A of the vehicle 104. In an embodiment, the processor 202 may be configured to provide the generated recommendation as an option for selection by the user 104A. The processor 202 may be configured to receive a user input to select the generated recommendation. The user input may correspond to, but is not limited to, a touch input, a tactile input, an audio input, or a gesture. In such a scenario, the user 104A may be notified before starting the driving session to avoid any warnings that might have a negative impact on the driving range of the vehicle 104. For example, the generated recommendations may be displayed on a display screen associated with the user device 412 (such as a mobile phone). In another example, the user 104A may be notified by using an audio signal, thereby rendering the recommendation via a set of speakers associated with the user device 412. As shown at 410A, the rendered recommendation may correspond to “there will be heavy rain and wind in 2 hours, you should leave now to protect your range from getting badly impacted, therefore avoiding having to charge tomorrow.”

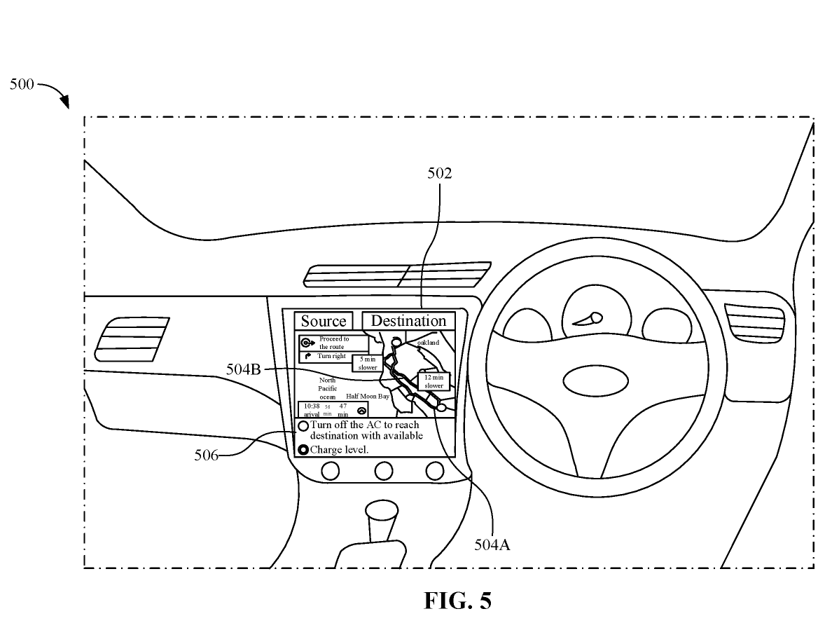

FIG. 5 is a diagram that illustrates a first exemplary scenario for depicting the rendering of recommendations on a user interface, in accordance with an embodiment of the disclosure. FIG. 5 is explained in conjunction with elements from FIG. 1, FIG. 2, FIG. 3 and FIG. 4. With reference to FIG. 5, there is shown the exemplary scenario 500 that includes an interior cabin of the vehicle 104. There is further shown, a display screen 502 of an infotainment system (such as the infotainment system 106).

In an embodiment, the apparatus 102 may be configured to generate the recommendation associated with the driving range in real-time. For example, the apparatus 102 may analyze the user profile data 204A and the first contextual information 304A associated with the first driving session. Based on the analysis, the apparatus 102 may determine a deviation in the historical charging information 204C. The apparatus 102 may be configured to generate the recommendation 506 based on the deviation, such as based on the current charging level in order to maintain the usual mobility pattern. For example, as shown in the FIG. 5 there is displayed a map 504A depicting a route 504B to be traversed by the vehicle 104 to travel from a source and a destination point. Further, the generated recommendation 506 may be rendered on the display screen 502 such as “turn off the AC to reach destination with available charge level.”

For example, the apparatus 102 may be configured to recommend to the user 104A such as, but not limited to, a suggestion to take a different route, a suggestion to drive at a different speed, a suggestion to lower cooling/heater, or a suggestion to make the trip at a different time based on a current charging level to be able to maintain the usual mobility pattern.

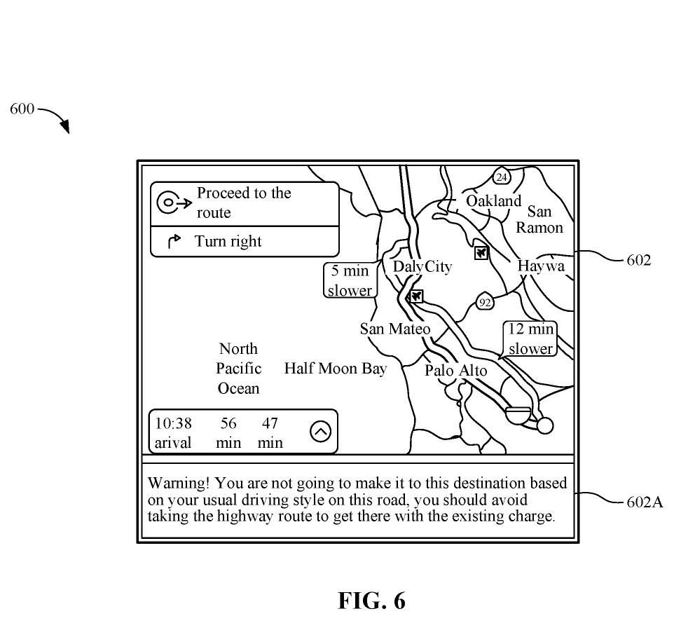

FIG. 6 is a diagram that illustrates a second exemplary scenario for depicting the rendering of recommendations, in accordance with an embodiment of the disclosure. FIG. 6 is explained in conjunction with elements from FIG. 1, FIG. 2, FIG. 3, FIG. 4, and FIG. 5. With reference to FIG. 6, there is shown the exemplary scenario 600 that includes a display screen 602 of an infotainment system (such as the infotainment system 106).

For example, as shown in the FIG. 6, there is displayed a map depicting a route to be traversed by the vehicle 104 to travel from a source and a destination point. Further, the generated recommendation 602A may be rendered on the display screen 602 such as “WARNING! You are not going to make it to this destination based on your usual driving style on this road, you should avoid taking the highway route to get there with the existing charge.”

In an embodiment, the apparatus 102 may be configured to generate the recommendations associated with available driving range in real-time. For example, in a scenario when the vehicle 104 may be a bit short of the range, the apparatus 102 may generate recommendations such as, “You are not going to make it to the current destination based on your usual driving style on this road but here is what you need to change in order to get there with the existing charge, take a different route, drive at a different speed, lower cooling/heater in order to maintain the usual mobility pattern” In another example, the recommendation may be a suggestion to make the trip at a different time based on current charging level, such as “take a break for 30 minutes on the restaurant nearby and save the available charge by avoiding the traffic jam.”

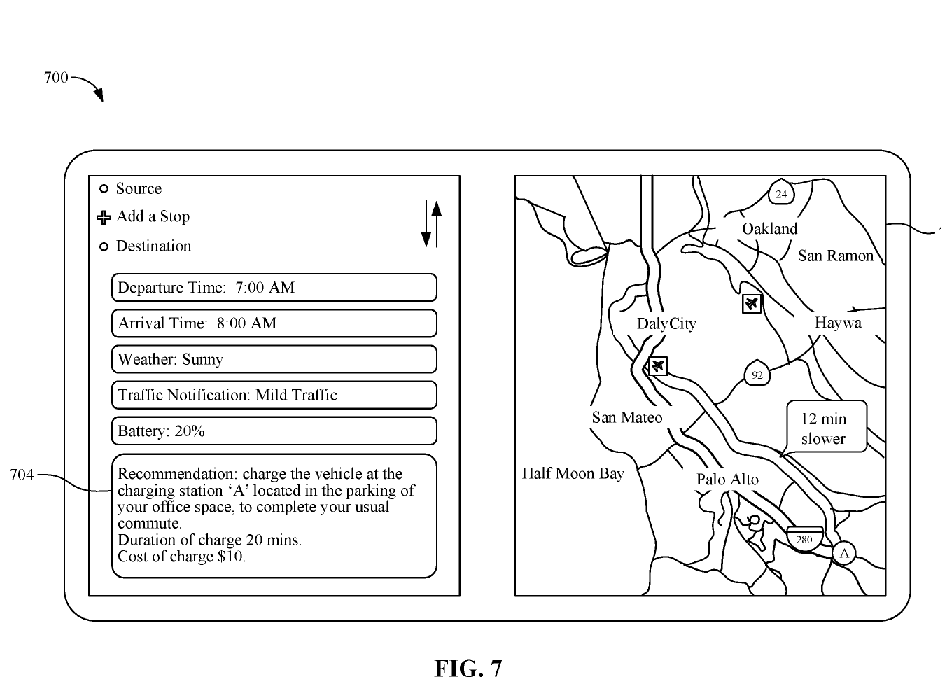

FIG. 7 is a diagram that illustrates a third exemplary scenario for depicting the rendering of recommendations on a user interface, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown the exemplary scenario 700 that includes a display screen 702 of an infotainment system (such as the infotainment system 106).

For example, as shown in the FIG. 7 there is displayed a map depicting a route to be traversed by the vehicle 104 to travel from a source and a destination point. Further, the display screen 702 may include, but is not limited to, information associated with a departure time (such as 7:00 am) from the source, an arrival time (such as 8:00 am) at the destination, weather information (such as, sunny) associated with the location, a traffic notification (such as mild traffic) associated with the route to be traversed, and an available charge level (such as 20%).

In a scenario when the vehicle 104 may be missing a lot of range, the apparatus 102 may generate recommendation 704 such as “charge the vehicle at the charging station ‘A’ located in the parking of your office space, to complete your usual commute.” The recommendation 704 may further include but is not limited to information associated with a location of the charging station, a minimum duration of charge required such as 20 minutes, or cost information associated with the charge for the said duration, such as $10.

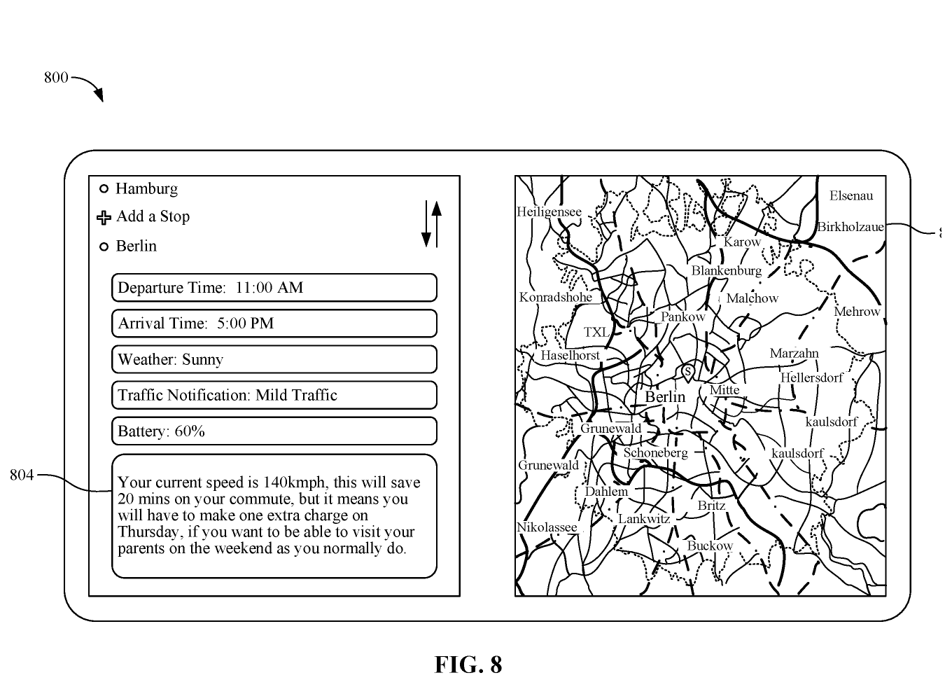

FIG. 8 is a diagram that illustrates a fourth exemplary scenario for depicting the rendering of recommendations on a user interface, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown the exemplary scenario 800 that includes a display screen 802 of an infotainment system (such as the infotainment system 106).

For example, as shown in the FIG. 8 there is displayed a map depicting a route to be traversed by the vehicle 104 to travel from a source (such as Hamburg) and a destination point (such as Berlin). Further, the display screen 802 may include, but is not limited to, information associated with a departure time (such as 11:00 am) from the source, an arrival time (such as 5:00 pm) at the destination, a weather information (such as sunny) associated with the location, a traffic notification (such as mild traffic) associated with the route to be traversed, and an available charge level (such as 60%).

In such a scenario, the apparatus 102 may generate recommendation 804 such as “Your current speed is 140kmph, this will save 20 mins on your commute, but it means you will have to make one extra charge on Thursday, if you want to be able to visit your parents on the weekend as you normally do.” In an embodiment, the apparatus 102 may be configured to render the deviations associated with the vehicle driving behavior and generate recommendations in real-time. For example, if there is a deviation in the current vehicle driving behavior in comparison to the historical usage of the vehicle, such as, the user 104A may step into vehicle 104, and set the heat system on high while driving on a highway in addition to speeding in contrast to the historical usage of the vehicle 104 on the highway. Then, the apparatus 102 may be configured to notify such deviations to the user 104A by rendering the deviations on the user interface 106A. Further, the apparatus 102 may be configured to provide immediate feedback on expected future consequences based on the determined deviations, like “if you continue driving like this with the heating system set high, you may have to make a charge on Wednesday instead of Saturday."

Thereafter, the apparatus 102 may employ the first contextual information 304A associated with the first driving session to notify the user 104A of such consequences. This may allow the user 104A to better understand such a recommendation. For example, the user 104A may be fine charging on Wednesday, since it is a bank holiday, therefore, there might not be any effect on the mobility pattern of the user 104A. In another example, there might be a forecast of rain on Thursday which anyway will lead to cancellation of the golf exercise later in the week and save some range. Therefore, the disclosed apparatus 102 may quickly adapt to the real-time as well as future conditions and provide recommendations accordingly.

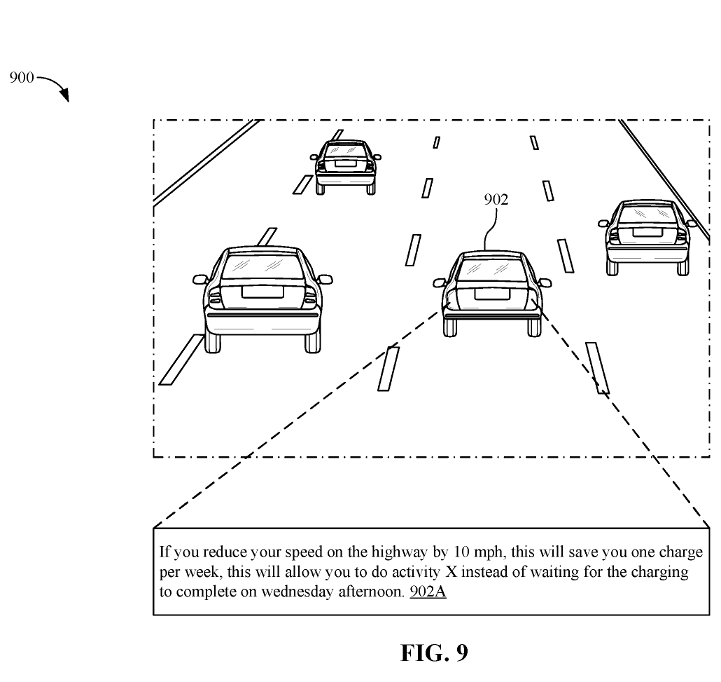

FIG. 9 is a diagram that illustrates a fifth exemplary scenario for depicting the rendering of recommendations on a user interface, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. With reference to FIG. 9, there is shown the exemplary scenario 900 that includes a vehicle 902 driving in a lane on the road. The recommendation 902A may correspond to a notification on the infotainment system such as, “If you reduce your speed on the highway by 10kmph, this will save you one charge per week and allow you to do activity X instead of waiting for the charging to complete on Wednesday afternoon.”

In another example, there might be a temperature drop of 10 degrees in the last 2 weeks, the apparatus 102 may determine that such a deviation like that may have an impact on the driving range and thereby resulting in the deviation in the usage of the vehicle driving behavior. The apparatus 102 may generate the recommendation associated with the driving range based on the determined deviation.

The disclosed apparatus 102 may be configured to generate optimal recommendations associated with the driving range in order to maintain the usual vehicle driving pattern, thereby making the adoption of the electronic vehicle more reliable. Such recommendations enhance the user experience, since the apparatus 102 may notify the consequences of the deviation in addition to the recommendation. For example, the user may prefer to charge once a week rather than twice a week, the apparatus 102 may receive such a user request and recommend possible modification in the driving behavior to complete the user request.

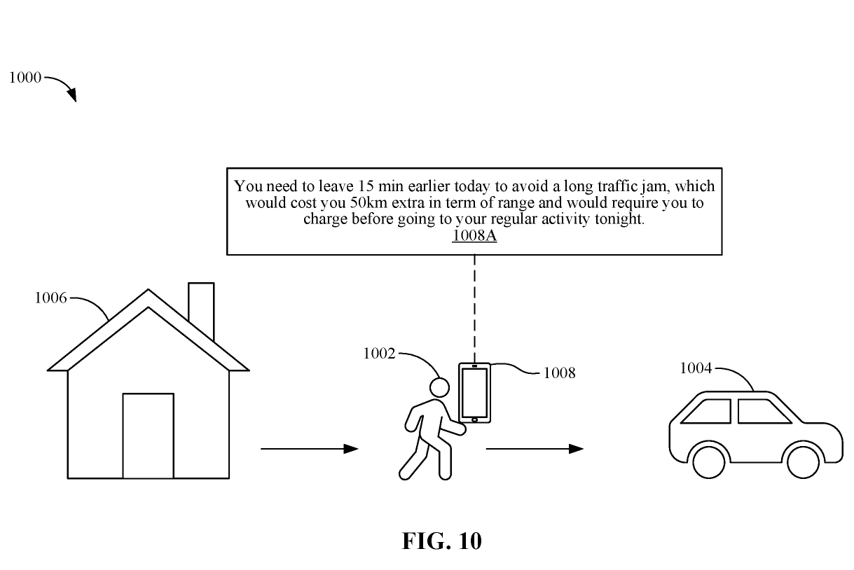

FIG. 10 is a diagram that illustrates a sixth exemplary scenario for depicting the rendering of recommendations on a user interface for a scheduled driving session, in accordance with an embodiment of the disclosure. FIG. 10 is explained in conjunction with elements from FIG. 1, FIG. 2, FIG. 3, FIG. 4, FIG. 5, FIG. 6, FIG. 7, FIG. 8, and FIG. 9. With reference to FIG. 10, there is shown the exemplary scenario 1000 that includes a user 1002, exiting home 1006 and approaching their vehicle 1004. The user 1002 may receive the recommendation associated with the scheduled driving session on the user device 1008. The recommendation 1008A may correspond to a notification on the user device 1008 such as, “You need to leave 15 minutes earlier today to avoid a long traffic jam, which would cost you 50km extra in terms of range and would require you to charge before going to your regular activity tonight.”

In an embodiment, the apparatus 102 may be configured to render the recommendation on the user interface 106A associated with the user device 1008. For example, the apparatus 102 of FIG. 1 may be communicatively coupled with an online platform associated with monitoring the vehicle 1004. In one example, the user 1002 may be notified by an application associated with the online platform (such as, but not limited to, an original equipment manufacturer (OEM) app, navigation app, weather app, or vehicle health monitoring app). The apparatus 102 may be configured to determine the modification in the weather information, thereby generating the recommendation associated with an early departure in order to maintain mobility and charge patterns. For example, the apparatus 102 may determine the weather-related impact and related adjustments, such as there will be heavy rain and wind in 2 hours. In this example, the apparatus 102 may notify the user via the online platform such as “you should rather leave for your destination now in order not to save your range that may be badly impacted by the weather and therefore avoid having to charge tomorrow”.

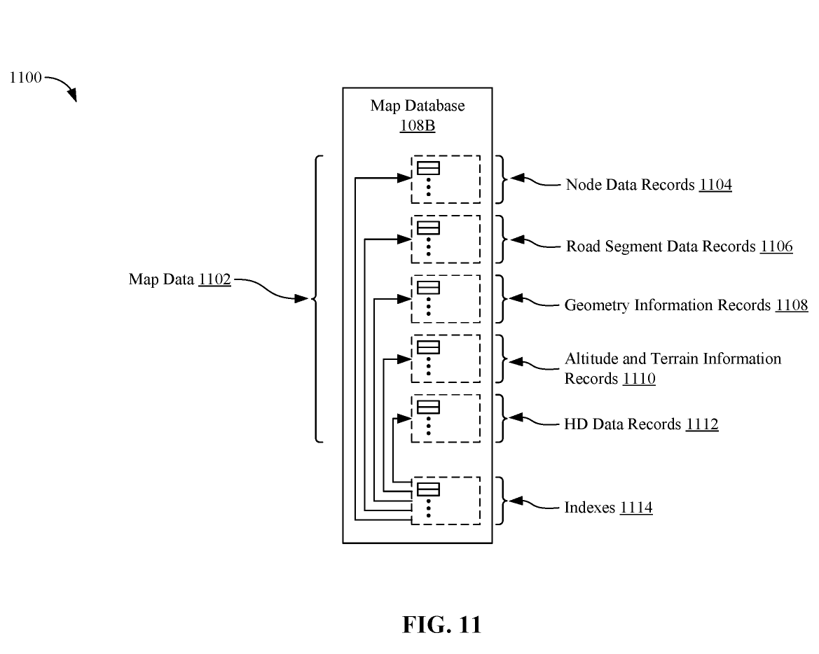

FIG. 11 is a diagram of the map database, in accordance with an embodiment of the disclosure. FIG. 11 is explained in conjunction with elements from FIG. 1, FIG. 2, FIG. 3, FIG. 4, FIG. 5, FIG. 6, FIG. 7, FIG. 8, FIG. 9, and FIG. 10. With reference to FIG. 11, there is shown the exemplary block diagram 1100 that includes the map database 108B includes map data 1102 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the map data 1102. In one embodiment, the map database 108B includes high definition (HD) mapping data that provide centimeter-level or better accuracy of map features. For example, the map database 108B can be based on Light Detection and Ranging (LiDAR) or equivalent technology to collect billions of 3D points and model road surfaces and other map features down to the number of lanes and their widths. In one embodiment, the HD mapping data (e.g., HD data records 1112) and/or other mapping data of the map database 108B capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, and roadside objects such as signposts, including what the signage denotes. By way of example, the HD mapping data enables highly automated vehicles to precisely localize themselves on the road.

In one embodiment, geographic features (e.g., two-dimensional, or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent the footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the map database 108B.

“Node” – A point that terminates a link.

“Line segment” – A straight line connecting two points.

“Link” (or “edge”) – A contiguous, non-branching string of one or more line segments terminating in a node at each end.

“Shape point” – A point along a link between two nodes (e.g., used to alter the shape of the link without defining new nodes).

“Oriented link” – A link that has a starting node (referred to as the “reference node”) and an ending node (referred to as the “non-reference node”).

“Simple polygon” – An interior area of an outer boundary formed by a string of oriented links that begins and ends in one node. In one embodiment, a simple polygon does not cross itself.

“Polygon” – An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the map database 108B follows certain conventions. For example, links do not cross themselves and do not cross each other except at a node. Also, there are no duplicated shape points, nodes, or links. Two links that connect each other have a common node. In the map database 108B, overlapping geographic features are represented by overlapping polygons. When polygons overlap, the boundary of one polygon crosses the boundary of the other polygon. In the map database 108B, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the map database 108B includes node data records 1104, road segment or link data records 1106, geometry information records 1108, altitude and terrain information records 1110, HD data records 1112, and indexes 1114, for example. In some examples, the user profile data 204A may be stored as the node data records 1104, the road segment or the link data records 1106, the geometry information records 1108, the altitude and terrain information records 1110, the HD data records 1112, and the indexes 1114. More, fewer, or different data records can be provided. In some embodiments, the altitude and terrain information records 1110 may be stored in the map database 108B. In one embodiment, additional data records (not shown) can include cartographic (“carto”) data records, routing data, and maneuver data. In one embodiment, the indexes 1114 may improve the speed of data retrieval operations in the map database 108B. In one embodiment, the indexes 1114 may be used to quickly locate data without having to search every row in the map database 108B every time it is accessed. For example, in one embodiment, the indexes 1114 can be a spatial index of the polygon points associated with stored feature polygons. In one or more embodiments, data of a data record may be attributes of another data record.

In exemplary embodiments, the road segment data records 1106 are links or segments representing roads, streets, paths, or bicycle lanes, as can be used in the calculated route or recorded route information for the determination of speed profile data. The node data records 1104 are endpoints (for example, representing intersections or an end of a road) corresponding to the respective links or segments of the road segment data records 1106. The road segment data records 1106 and the node data records 1104 represent a road network, such as used by vehicles, cars, and/or other entities. Alternatively, the map database 108B can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation-related attributes, as well as POIs, such as gasoline stations, hotels, restaurants, museums, stadiums, offices, automobile dealerships, auto repair shops, buildings, stores, parks, etc. The map database 108B can include data about the POIs and their respective locations in the geometry information records 1108. The map database 108B can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or map feature data can be part of the geometry information records 1108.

In one embodiment, the map database 108B can also include the altitude and terrain information records 1110 for altitude and terrain information associated with the links, and/or any other related data that is used or generated according to the embodiments described herein. By way of example, the altitude and terrain information records 1110 can be associated with one or more of the node records 1104, the road segment records 1106, and/or the geometry information records 1108 to associate the speed profile data records with specific places, POIs, geographic areas, and/or other map features. In this way, the linearized data records can also be associated with the characteristics or metadata of the corresponding records 1104, 1106, and/or 1108.

In one embodiment, as discussed above, the HD data records 1112 model road surfaces and other map features to centimeter-level or better accuracy. The HD data records 1112 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD data records 1112 are divided into spatial partitions of varying sizes to provide HD mapping data to end-user devices with near real-time speed without overloading the available resources of the devices (e.g., computational, memory, bandwidth, etc. resources).

In one embodiment, the HD data records 1112 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD data records 1112.

In one embodiment, the HD data records 1112 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the map database 108B can be maintained by the content provider in association with the mapping platform 108 (e.g., a map developer or service provider). The map developer can collect geographic data to generate and enhance the map database 108B. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The map database 108B can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end-user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicle and/or the UE. The navigation-related functions can correspond to vehicle navigation, pedestrian navigation, or other types of navigation. The compilation to produce the end-user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for processing the location sensor data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Exemplary hardware for performing the described functions is detailed below.

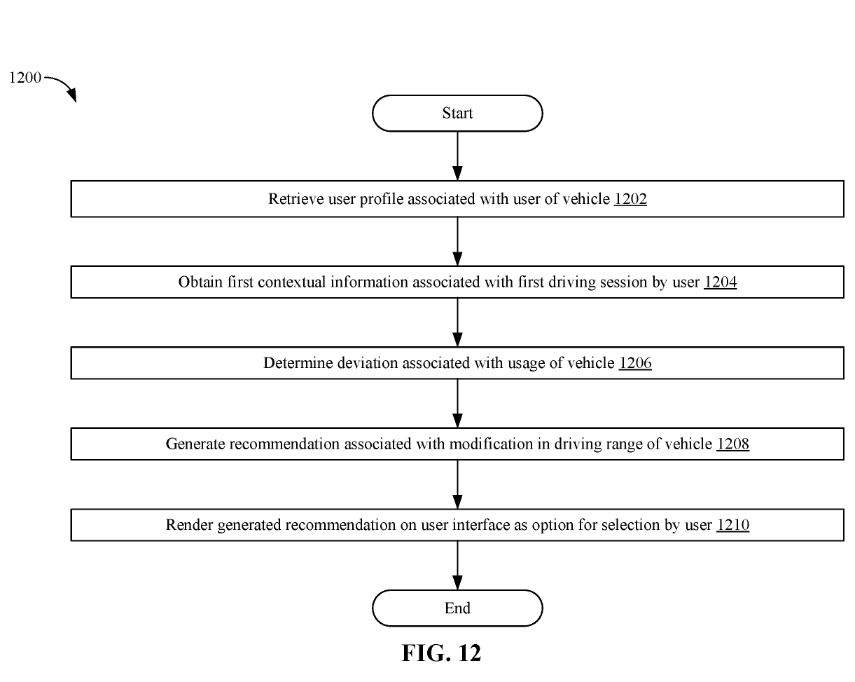

FIG. 12 is a flowchart that illustrates an exemplary method for the determination of deviation in vehicle driving behavior and generating recommendations, in accordance with an embodiment of the disclosure. FIG. 12 is explained in conjunction with elements from FIGS. 1, 2, 3, 4, 5, 6, 7, 8, 9, 10 and 11. With reference to FIG. 12, there is shown the flowchart 1200. The operations of the exemplary method may be executed by any computing system, for example, by the apparatus 102 of FIG. 1 or the processor 202 of FIG. 2. The operations of the flowchart 1200 may start at 1202.

At 1202, user profile data may be retrieved. In an embodiment, the apparatus 102 may be configured to retrieve the user profile data 204A associated with the user 104A of the vehicle 104. The user profile data 204A may include historical usage information 204B of the vehicle 104 during one or more historical driving sessions by the user 104A. The user profile data 204A may further include the charging information 204C associated with one or more historical charging sessions of the electric vehicle. In at least one embodiment, the processor 202 may be configured to retrieve the user profile data 204A associated with the user 104A of the vehicle 104. Details about the user profile data are provided, for example, in FIGS. 1and3A.

At 1204, first contextual information may be obtained. In an embodiment, the apparatus 102 may be configured to obtain the first contextual information 304A associated with a first driving session by the user 104A. In at least one embodiment, the processor 202 may be configured to obtain the first contextual information 304A associated with a first driving session by the user 104A, as described, for example, in FIGS. 1 and 3A.

At 1206, a deviation may be determined. In an embodiment, the apparatus 102 may be configured to determine the deviation associated with a usage of the vehicle 104 based on the retrieved user profile data 204A and the obtained first contextual information 304A. In at least one embodiment, the processor 202 may be configured to determine the deviation associated with a usage of the vehicle 104 based on the retrieved user profile data 204A and the obtained first contextual information 304A. Details about the determination of the deviation associated with the usage of the vehicle 104 are provided, for example, in FIGs.1 and 3A.

At 1208, a recommendation may be generated. In an embodiment, the apparatus 102 may be configured to generate the recommendation associated with a modification in a driving range of the vehicle 104 based on the determined deviation. In at least one embodiment, the processor 202 may be configured to generate the recommendation associated with a modification in a driving range of the vehicle 104 based on the determined deviation. Details about generating the recommendation are provided, for example, in FIGS. 3A, 5, 6, 7, 8, 9 and 10.

At 1210, the recommendation may be rendered on a user interface, as an option, for selection by the user 104A. In at least one embodiment, the processor 202 may be configured to render the generated recommendation on the user interface 106A as an option for selection by the user 104A, as described, in FIGS. 5, 6, 7, 8, 9, and 10. Control may pass to the end.

Accordingly, blocks of the flowchart 1200 support combinations of means for performing the specified functions and combinations of operations for performing the specified functions. It will also be understood that one or more blocks of the flowchart 1200 can be implemented by special-purpose hardware-based computer systems which perform the specified functions, or combinations of special-purpose hardware and computer instructions.

Alternatively, the apparatus 102 of FIG. 1 may comprise means for performing each of the operations described above. In this regard, according to an example embodiment, examples of means for performing operations may comprise, for example, the processor 202 of FIG. 2 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus, comprising at least one processor and at least one non-transitory memory including computer program code instructions, the computer program code instructions configured to, when executed, cause the apparatus to:
retrieve user profile data associated with a user of a vehicle, wherein the user profile data comprises historical usage information of the vehicle during one or more historical driving sessions by the user;
obtain first contextual information associated with a first driving session by the user;
determine a deviation associated with a usage of the vehicle based on the retrieved user profile data and the obtained first contextual information;
generate a recommendation associated with a modification in a driving range of the vehicle based on the determined deviation; and
provide, via a user interface, the generated recommendation as an option for selection by the user.

2. The apparatus of claim 1, wherein the vehicle is an electric vehicle, and wherein the user profile data further comprises charging information associated with one or more historical charging sessions of the electric vehicle.

3. The apparatus of claim 2, wherein the charging information associated with the one or more historical charging sessions of the electric vehicle comprises: timestamp information associated with each charging session of the one or more historical charging sessions, location information associated with each charging session of the one or more historical charging sessions, cost information associated with each charging session of the one or more historical charging sessions, or a combination thereof.

4. The apparatus of claim 1, wherein the historical usage information of the vehicle comprises: timestamp information associated with each driving session of the one or more historical driving sessions, route information associated with each driving session of the one or more historical driving sessions, weather information associated with a location of the vehicle or a route be traversed by the vehicle during each driving session of the one or more historical driving sessions, occupancy information associated with the vehicle during each driving session of the one or more historical driving sessions, speed information associated with the vehicle during each driving session of the one or more historical driving sessions, vehicle information associated with the vehicle, or a combination thereof.

5. The apparatus of claim 1, wherein the first contextual information associated with the vehicle comprises vehicle information associated with the vehicle during the first driving session, charging information associated with the vehicle during the first driving session, route information associated with the first driving session, traffic information associated with a route to be traversed by the vehicle during the first driving session, weather information associated with a location of the vehicle or the route to be traversed by the vehicle during the first driving session, or a combination thereof.

6. The apparatus of claim 1, wherein the deviation in the usage of the vehicle during the first driving session is determined based on one of: a modification in vehicle health information associated with the vehicle, a modification in charge information associated with the vehicle, a modification in speed information associated with the vehicle, a modification in route information associated with the first driving session, a modification in traffic information associated with a route to be traversed by the vehicle, a modification in occupancy information associated with the vehicle during the first driving session, environment information during the first driving session, or a combination thereof.

7. The apparatus of claim 1, wherein the generated recommendation associated with the modification in the driving range of the vehicle corresponds to: a modification in a speed associated with the vehicle, a modification in charge information associated with the vehicle, a modification in vehicle health information associated with the vehicle, a modification in a route to be traversed by the vehicle, a modification in one or more parameters of one or more electronic devices associated with the vehicle, a modification in a start time associated with the first driving session, or a combination thereof.

8. The apparatus of claim 7, wherein the one or more electronic devices associated with the vehicle comprises at least one of: a Heating, Ventilation, and Air Conditioning system, an infotainment system, an on-board diagnostics system, a Tire Pressure Monitoring System, a Battery Management System, a vehicle control unit, a navigation system, and an Advanced Driver Assistance System.

9. The apparatus of claim 1, wherein the computer program code instructions are configured to, when executed, cause the apparatus to control one or more parameters of one or more electronic devices associated with the vehicle based on a selection of the generated recommendation.

10. The apparatus of claim 1, wherein the computer program code instructions are configured to, when executed, cause the apparatus to:
receive a user input associated with the modification in the driving range of the vehicle; and
generate the recommendation associated with the modification in the driving range of the vehicle based on the received user input.

11. The apparatus of claim 1, wherein the computer program code instructions are configured to, when executed, cause the apparatus to:
receive a user input associated with a modification in one or more parameters of one or more electronic devices associated with the vehicle based on the generated recommendation; and
control the one or more parameters of the one or more electronic devices associated with the vehicle based on the received user input.

12. The apparatus of claim 1, wherein the computer program code instructions are configured to, when executed, cause the apparatus to:
apply a machine learning model on the retrieved user profile data and the obtained first contextual information; and
generate the recommendation associated with the modification in the driving range of the vehicle based on an output of the machine learning model.

13. A method for providing a user with a recommendation associated with a modification in a driving range of a vehicle, comprising the steps of:
retrieving user profile data associated with the user of the vehicle, wherein the user profile data comprises historical usage information of the vehicle during one or more historical driving sessions by the user;
obtaining first contextual information associated with a first driving session by the user;
determining a deviation associated with a usage of the vehicle based on the retrieved user profile data and the obtained first contextual information;
generating the recommendation associated with the modification in the driving range of the vehicle based on the determined deviation; and
rendering the generated recommendation on a user interface as an option for selection by the user.

14. The method of claim 13, wherein the vehicle is an electric vehicle, and wherein the user profile data further comprises charging information associated with one or more historical charging sessions of the electric vehicle.

15. The method of claim 13, further comprising the steps of:
receiving a user input associated with the modification in the driving range of the vehicle; and
generating the recommendation associated with the modification in the driving range of the vehicle based on the received user input.

16. The method of claim 13, further comprising the steps of:
receiving a user input associated with a modification in one or more parameters of one or more electronic devices associated with the vehicle based on the generated recommendation; and
controlling the one or more parameters of the one or more electronic devices associated with the vehicle based on the received user input.

17. The method of claim 13, wherein the user interface is displayed on at least one of an infotainment unit associated with the vehicle, or a user device associated with the user of the vehicle.

18. A non-transitory computer-readable storage medium having computer program code instructions stored therein, the computer program code instructions, when executed by at least one processor, cause the at least one processor to:
retrieve user profile data associated with a user of a vehicle, wherein the user profile data comprises historical usage information of the vehicle during one or more historical driving sessions by the user;
obtain first contextual information associated with a first driving session by the user;
determine a deviation associated with a usage of the vehicle based on the retrieved user profile data and the obtained first contextual information;
generate a recommendation associated with a modification in a driving range of the vehicle based on the determined deviation; and
provide, via a user interface, the generated recommendation as an option for selection by the user.

19. The non-transitory computer-readable storage medium of claim 18, wherein the computer program code instructions are configured to, when executed, cause the at least one processor to:
receive a user input associated with the modification in the driving range of the vehicle; and
generate the recommendation associated with the modification in the driving range of the vehicle based on the received user input.

20. The non-transitory computer-readable storage medium of claim 18, wherein the computer program code instructions are configured to, when executed, cause the at least one processor to:
receive a user input associated with a modification in one or more parameters of one or more electronic devices associated with the vehicle based on the generated recommendation; and
control the one or more parameters of the one or more electronic devices associated with the vehicle based on the received user input.
